(19) United States
(12) Patent Application Publication
(10) Pub. No.: US 2026/0181509 A1
(43) Pub. Date: Jun. 25, 2026

(54) Enhanced Mobility Optimization Using UE Trajectory Prediction

(71) Applicant: Telefonaktiebolaget LM Ericsson (publ), Stockholm (SE)

(72) Inventors: Germán Bassi, Årsta (SE); Philipp Bruhn, Aachen (DE); Angelo Centonza, Granada (ES); Luca Lunardi, Genova (IT); Reem Karaki, Aachen (DE)

(21) Appl. No.: 19/126,506

(22) PCT Filed: Nov. 2, 2023
(86) PCT No.: PCT/SE2023/051111

§ 371 Date: May 1, 2025

Related U.S. Application Data
(60) Provisional application No. 63/422,297, filed on Nov. 3, 2022.
(60) Provisional application No. 63/518,685, filed on Aug. 10, 2023.

(51) Int. Cl. H04W 36/32; H04W 36/00

(52) U.S. Cl. CPC H04W 36/32; H04W 36/00835

(57) ABSTRACT

A RAN node distributes information about UE trajectory predications to other network nodes, such as other RAN nodes, core network nodes, or external systems The UE trajectory prediction can be used, for example, to optimize handovers of the UE from the RAN node signaling the UE trajectory prediction to another RAN node.

### TECHNICAL FIELD

The present disclosure relates generally to handover procedures in a wireless communication network and, more particularly, to handover optimization using a prediction of user equipment (UE) trajectory.

### BACKGROUND

The Third Generation Partnership Project (3GPP) is working on a study item (SI) for radio access networks (RANs) titled “Study on enhancement for data collection for NR and EN-DC.” to provide general high-level principles, functional framework, and potential use cases for an artificial intelligence (AI) AI-enabled RAN. The results of the study are documented in 3GPP Technical Report (TR) 37.817 v17.0.0. One conclusion of this study is that the “Model Inference function should signal the outputs of the model only to nodes that have explicitly requested them (e.g., via subscription), or nodes that take actions based on the output from Model Inference.” The motivation behind this principle is to avoid unnecessary signaling in the network. The study generally describes that AI and/or machine learning (ML) based mobility optimization can generate as output, among other information, user equipment (UE) trajectory predictions (e.g., latitude, longitude, altitude, cell identifier (ID) of UE over a future period of time). Whether the UE trajectory prediction is an external output to the node hosting the Model Inference function will be determined during the normative work phase.

Predicted cell-granularity UE trajectory can be exchanged over the Xn interface for AI/ML based mobility optimization. The cell-based UE trajectory prediction may have the same structure as the UE History Information (HI) Information Element (IE). The cell-based UE trajectory prediction can be provided as a list of cells through which the UE is predicted to travel together with an expected time that the UE will remain in the cell.

Signaling procedures for implementation of AI/ML-based RAN optimization problem have yet to be specified. Two main areas of concern with signaling procedures are minimizing increases to signaling overhead and limiting access to UE trajectory predictions.

### SUMMARY

The present solution provides methods enabling a RAN node to distribute information about UE trajectory predications to other network nodes, such as other RAN nodes, core network nodes (e.g., Operations and Management (OAM) nodes, or external systems (e.g., Service management and Orchestration (SMO) system). The UE trajectory prediction can be used, for example, to optimize handovers of the UE from the RAN node signaling the UE trajectory prediction to another RAN node.

A first aspect of the disclosure comprises methods implemented by a first RAN node configured to provide UE trajectory predictions. In one embodiment, the method comprises receiving a subscription request for user equipment (UE) trajectory prediction information, the subscription request including a condition for reporting the UE trajectory prediction information. The method further comprises, when the condition for reporting of UE trajectory prediction information is fulfilled, transmitting the UE trajectory prediction information to one or more subscribed network nodes based on the subscription request.

A second aspect of the disclosure comprises a first RAN node configured to provide UE trajectory predictions. The first RAN node is configured to receive a subscription request for user equipment (UE) trajectory prediction information. The subscription request includes a condition for reporting the UE trajectory prediction information. The first RAN node is further configured to, when the condition for reporting of UE trajectory prediction information is fulfilled, transmitting the UE trajectory prediction information to one or more subscribed network nodes based on the subscription request.

A third aspect of the disclosure comprises a first RAN node configured to provide UE trajectory predictions. The first RAN node comprises interface circuitry for communicating with other network nodes, and processing circuitry operatively connected to the interface circuitry. The processing circuitry is configured to receive a subscription request for user equipment (UE) trajectory prediction information. The subscription request includes a condition for reporting the UE trajectory prediction information. The RAN node is further configured to, when the condition for reporting of UE trajectory prediction information is fulfilled, transmitting the UE trajectory prediction information to one or more subscribed network nodes based on the subscription request.

A fourth aspect of the disclosure comprises a computer program for a RAN node. The computer program comprises executable instructions that, when executed by processing circuitry in the first RAN node, causes the first RAN node to perform the method according to the first aspect.

A fifth aspect of the disclosure comprises a carrier containing a computer program according to the fourth aspect. The carrier is one of an electronic signal, optical signal, radio signal, or a non-transitory computer readable storage medium.

A sixth aspect of the disclosure comprises methods implemented by a second RAN node configured to subscribe to a UE trajectory prediction service. In one embodiment, the method comprises transmitting a subscription request for user equipment (UE) trajectory prediction information to a first RAN node. The subscription request includes a condition for reporting the UE trajectory prediction information. The method further comprises, when the condition for reporting of UE trajectory prediction information is fulfilled, receiving the UE trajectory prediction information from the first RAN node.

A seventh aspect of the disclosure comprises a second RAN node configured to subscribe to a UE trajectory prediction service of a first RAN node. The RAN node is configured to transmit a subscription request for user equipment (UE) trajectory prediction information to a first RAN node. The subscription request includes a condition for reporting the UE trajectory prediction information. The second RAN node is further configured to, when the condition for reporting of UE trajectory prediction information is fulfilled, receiving the UE trajectory prediction information from the first RAN node.

An eighth aspect of the disclosure comprises a second RAN node configured to subscribe to a UE trajectory prediction service of a first RAN node. The second RAN node comprises interface circuitry for communicating with the first RAN node, and processing circuitry operatively connected to the interface circuitry. The processing circuitry is configured to transmit a subscription request for user equipment (UE) trajectory prediction information to a first RAN node. The subscription request includes a condition for reporting the UE trajectory prediction information. The second RAN node is further configured to, when the condition for reporting of UE trajectory prediction information is fulfilled, receiving the UE trajectory prediction information from the first RAN node.

A ninth aspect of the disclosure comprises a computer program for a second RAN node configured to subscribe to a UE trajectory prediction service of a first RAN node. The computer program comprises executable instructions that, when executed by processing circuitry in the second RAN node, causes the second RAN node to perform the method according to the sixth aspect.

A tenth aspect of the disclosure comprises a carrier containing a computer program according to the ninth aspect. The carrier is one of an electronic signal, optical signal, radio signal, or a non-transitory computer readable storage medium.

An eleventh aspect of the disclosure comprises methods implemented by a network node in a wireless communication network configured for subscribing to a UE trajectory prediction service. In one embodiment, the method comprises transmitting a subscription request for user equipment (UE) trajectory prediction information to a first radio access network (RAN) node. The subscription request includes a condition for reporting the UE trajectory prediction information. The subscription request may be sent to the first RAN node on behalf of a second RAN node.

A twelfth aspect of the disclosure comprises a network node in a wireless communication network configured to subscribe to a UE trajectory prediction service of a first RAN node. The network node is configured to transmit a subscription request for user equipment (UE) trajectory prediction information to a first radio access network (RAN) node. The subscription request includes a condition for reporting the UE trajectory prediction information. The subscription request may be sent to the first RAN node on behalf of a second RAN node.

A thirteenth aspect of the disclosure comprises a network node in a wireless communication network configured to subscribe to a UE trajectory prediction service of a first RAN node. The second RAN node includes interface circuitry for communicating with the first RAN node, and processing circuitry operatively connected to the interface circuitry. The processing circuitry is configured to transmit a subscription request for user equipment (UE) trajectory prediction information to a first radio access network (RAN) node. The subscription request includes a condition for reporting the UE trajectory prediction information. The subscription request may be sent to the first RAN node on behalf of a second RAN node.

A fourteenth aspect of the disclosure comprises a computer program for a network node in a wireless communication network. The computer program comprises executable instructions that, when executed by processing circuitry in the network node, causes the network node to perform the method according to the eleventh aspect.

A fifteenth aspect of the disclosure comprises a carrier containing a computer program according to the fourteenth aspect. The carrier is one of an electronic signal, optical signal, radio signal, or a non-transitory computer readable storage medium.

A sixteenth aspect of the disclosure comprises methods implemented by a source RAN node in a wireless communication network providing a UE trajectory prediction service. In one embodiment, the method comprises receiving, from a requesting node, a subscription request for trajectory prediction information indicative of a predicted trajectory for each of one or more UEs in a group of UEs served by the source RAN node. The method further comprises detecting a need to handover a target UE in the group of UEs served by the source RAN node to a target RAN node and sending a handover request from the source RAN node to the target RAN node. The handover request includes a UE trajectory prediction for the target UE.

A seventeenth aspect of the disclosure comprises a source RAN node configured to provide UE trajectory prediction service. The source RAN node is configured to receive, from a requesting node, a subscription request message requesting trajectory prediction information indicative of a predicted trajectory for each of one or more UEs in a group of UEs served by the source RAN node. The source RAN node is further configured to detect a need to handover a target UE in the group of UEs served by the source RAN node to a target RAN node. The source RAN node is configured to send a handover request from the source RAN node to the target RAN node. The handover request includes a UE trajectory prediction for the target UE.

An eighteenth aspect of the disclosure comprises a source RAN node configured to provide UE trajectory prediction service. The source RAN node comprises interface circuitry for communicating with other network nodes, and processing circuitry operatively connected to the interface circuitry. The processing circuitry is configured to receive, from a requesting node, a subscription request message requesting trajectory prediction information indicative of a predicted trajectory for each of one or more UEs in a group of UEs served by the source RAN node. The processing circuitry is further configured to detect a need to handover a target UE in the group of UEs served by the source RAN node to a target RAN node. The processing circuitry is configured to send a handover request from the source RAN node to the target RAN node. The handover request includes a UE trajectory prediction for the target UE.

A nineteenth aspect of the disclosure comprises a computer program for a source RAN node. The computer program comprises executable instructions that, when executed by processing circuitry in the source RAN node, causes the source RAN node to perform the method according to the sixteenth aspect.

A twentieth aspect of the disclosure comprises a carrier containing a computer program according to the nineteenth aspect. The carrier is one of an electronic signal, optical signal, radio signal, or a non-transitory computer readable storage medium.

A twenty-first aspect of the disclosure comprises methods implemented by a target RAN node in a wireless communication network of subscribing to UE trajectory prediction service. In one embodiment, the method comprises sending, to a source RAN node, a subscription request message requesting trajectory prediction information indicative of a predicted trajectory for each of one or more UEs in a group of UEs served by the source RAN node. The method further comprises receiving, from the source RAN node, a handover request for a target UE in the group of UEs served by the source RAN node. The handover request includes a UE trajectory prediction for a target UE in the group of one or more UEs.

A twenty-second aspect of the disclosure comprises a target RAN node configured to obtain UE trajectory predictions from a source RAN node. The target RAN node is configured to send, to a source RAN node, a subscription request message requesting trajectory prediction information indicative of a predicted trajectory for each of one or more UEs in a group of UEs served by the source RAN node. The target RAN node is further configured to receive, from the source RAN node, a handover request for a target UE in the group of UEs served by the source RAN node. The handover request includes a UE trajectory prediction for a target UE in the group of one or more UEs.

A twenty-third aspect of the disclosure comprises a target RAN node configured to obtain UE trajectory predictions from a source RAN node. The target RAN node comprises interface circuitry for communicating with the source RAN node, and processing circuitry operatively connected to the interface circuitry. The processing circuitry is configured to send, to a source RAN node, a subscription request message requesting trajectory prediction information indicative of a predicted trajectory for each of one or more UEs in a group of UEs served by the source RAN node. The processing circuitry is further configured to receive, from the source RAN node, a handover request for a target UE in the group of UEs served by the source RAN node. The handover request includes a UE trajectory prediction for a target UE in the group of one or more UEs.

A twenty-fourth aspect of the disclosure comprises a computer program for a target RAN node. The computer program comprises executable instructions that, when executed by processing circuitry in the target RAN node, causes the target RAN node to perform the method according to the twenty-first aspect.

A twenty-fifth aspect of the disclosure comprises a carrier containing a computer program according to the twenty-fourth aspect. The carrier is one of an electronic signal, optical signal, radio signal, or a non-transitory computer readable storage medium.

### BRIEF DESCRIPTION OF THE DRAWINGS

FIG. 1 illustrates an overall architecture for a wireless communication network.

FIG. 2 illustrates a gNB having a centralized unit and one or more distributed units (DUs)

FIG. 3 illustrates a predicted trajectory of a UE in a wireless communication network.

FIG. 4 illustrates an example subscription procedure for UE trajectory prediction information where a second RAN node sends a subscription request to a first RAN node providing UE trajectory predictions.

FIG. 5 illustrates an example subscription procedure for UE trajectory prediction information where a third network node sends a subscription request to the first RAN node on behalf of a second RAN node.

FIG. 6 illustrates an example subscription procedure for UE trajectory prediction information where a third network node subscribes directly with a first RAN node.

FIG. 7 illustrates example subscription procedures for UE trajectory prediction information.

FIG. 8 illustrates a handover procedure incorporating UE trajectory predictions.

FIG. 9 illustrates a method implemented by a first RAN node of providing UE trajectory predictions to other network nodes.

FIG. 10 illustrates a method implemented by a second RAN node of subscribing to a UE trajectory prediction service from a first RAN node.

FIG. 11 illustrates a method implemented by a third network node of subscribing to a UE trajectory prediction service of a first RAN node.

FIG. 12 is an exemplary method implemented by a source RAN node of transmitting a UE trajectory prediction in a handover message.

FIG. 13 is an exemplary method implemented by a target RAN node of receiving a UE trajectory prediction in a handover message.

FIG. 14 is a schematic diagram of a first RAN node configured to provide UE trajectory predictions.

FIG. 15 is a schematic diagram of a network node configured to subscribe to a UE trajectory prediction service of a first RAN node.

FIG. 16 is a schematic diagram of the main functional components of a network node, which can be configured to function as a RAN node, or core network node.

FIG. 17 illustrates an example communication network.

FIG. 18 illustrates an example of a UE in the communication network of FIG. 17.

FIG. 19 illustrates an example of a network node in the communication network of FIG. 17.

FIG. 20 illustrates a host device in the communication network of FIG. 17.

FIG. 21 illustrates a virtualization environment in which functions implemented by some embodiments may be virtualized.

FIG. 22 is a communication diagram of a host device communicating via a network node with a UE over a partially wireless connection in accordance with some embodiments.

### DETAILED DESCRIPTION

The present disclosure relates to handover optimization based on UE trajectory predictions. The techniques to signal UE trajectory predictions between different network nodes limit access to UE trajectory predictions and minimize or reduce signaling overhead by reusing existing signaling procedures. Generally, a first RAN in the 5G RAN receives subscription requests for UE trajectory predictions from neighboring RAN nodes or other network nodes. The subscription requests can specify conditions that, when fulfilled, cause the first RAN node to send a UE trajectory prediction to one or more subscribing network nodes.

As one example, the first RAN node may be a source RAN node currently serving a UE. The source RAN node may receive a subscription request from a second RAN node having a cell that lies along the trajectory of the UE. The cell of the second RAN node may be a candidate cell for a handover from a cell of the first RAN node, or may be a candidate cell for an anticipated future handover. The subscription request from the second RAN node may specify a condition that triggers the first RAN node to send a UE trajectory prediction to the second RAN node. The condition may be related, for example, to a mobility event (e.g., the UE moves into a specified cell or service area of a specified RAN node). When the condition is met, the first RAN node sends the UE trajectory prediction to the second RAN node.

Embodiments of the present disclosure will be described in the context of a Fifth Generation (5G) network. Those skilled in the art will appreciate, however, that the techniques described herein are more generally applicable to many types of wireless communication networks implementing UE trajectory prediction in the radio access network (RAN).

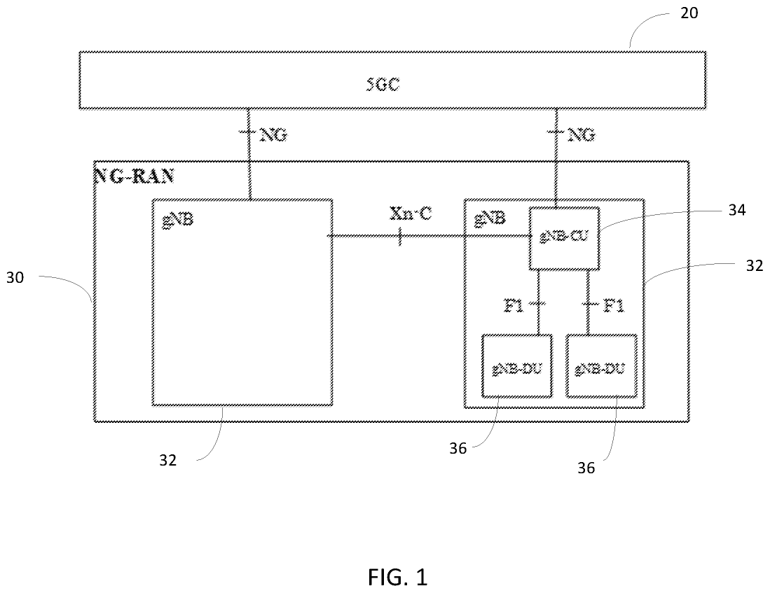

FIG. 1 illustrates an exemplary 5G wireless communication network 10 in which UE trajectory prediction is implemented. As specified in the 5G technical standard (TS) 38.300, the 5G wireless communication network 10 comprises a 5G Core (5GC) network 20 and a Next Generation RAN (NG-RAN) 30. The NG-RAN 30 comprises a set of base stations, which are referred to as Next Generation Node Bs (gNBs) 32. The gNBs 32 connect to the 5GC 20 via the NG interface. A gNB 32 can support frequency division duplex (FDD) mode, time division duplex (TDD) mode or dual mode operation. The gNBs 32 may be interconnected through an Xn or XN interface.

In some embodiments, the gNB 32 implements a split architecture where the functionality of the gNB 32 is split between a gNB-CU 34 and one or more gNB-DU(s) 36, which are connected via a F1 interface. One gNB-DU 36 is connected to only one gNB-CU 34, but a gNB-CU 34 can be connected to many gNB-DUs 36. Generally, the gNB-DU 36 implements the lower layers of the 5G protocol stack (e.g., Physical Layer and Medium Access Control Layer) and the gNB-CU 36 implements higher layers of the protocol stack (e.g., Radio Resource Control and packet Data Convergence Protocol (PDCP) layer). Those skilled in the art will appreciate, however, that other functional splits at different locations in the protocol stack are possible.

In a NG-RAN 30 having gNBs 32 with a split architecture, the Xn interface is between gNB-CUs 36 and is referred to as the XN-C interface. The NG and Xn-C interfaces for a gNB 32 terminate in the gNB-CU 32. For E-UTRA-NR Dual Connectivity (EN-DC), the S1-U and X2-C interfaces for a gNB 32 including a gNB-CU 34 and one or more gNB-DUs 36 terminate in the gNB-CU 34. The gNB-CU 34 and connected gNB-DUs 36 are only visible to other gNBs 32 and the 5GC 20 as a gNB 32.

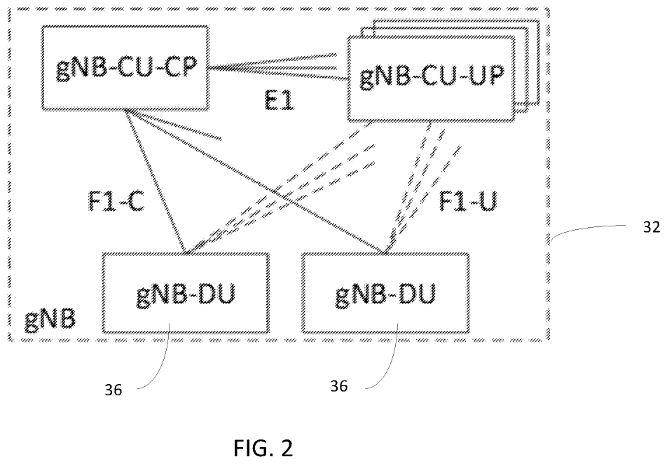

FIG. 2 illustrates the overall architecture for separation of gNB-CU control plane (gNB-CU-CP) and gNB-CU (gNB-CU-UPO. A gNB 32 may consist of a gNB-CU-CP, multiple gNB-CU-UPs and multiple gNB-DUs 34. The gNB-CU-CP is connected to the gNB-DU 36 through the F1-C interface. The gNB-CU-UP is connected to the gNB-DU 36 through the F1-U interface. The gNB-CU-UP is connected to the gNB-CU-CP through the E1 interface. One gNB-DU 36 is connected to only one gNB-CU-CP. One gNB-CU-UP is connected to only one gNB-CU-CP.

The architecture illustrated in FIG. 2 is defined by 3GPP for 5G. Other standardization groups, such as the Open RAN (O-RAN) Alliance, have further extended the architecture above and have for example split the gNB-DU into two further nodes connected by a fronthaul interface. The lower node of the split gNB-DU would contain the physical (PHY) protocol and the radio frequency (RF) parts, the upper node of the split gNB-DU would host the Radio Link Control (RLC) and medium access control (MAC). In O-RAN the upper node is referred to as O-DU, while the lower node is referred to as O-RU.

In the following discussion, the term RAN node is used to refer to a network node within the NG-RAN 30. The RAN node may, for example, comprise a gNB 32, gNB-CU 34, or gNB-DU 36.

One aspect of the disclosure comprises implementation of AI and/or machine learning (ML) based UE trajectory predictions (e.g., latitude, longitude, altitude, cell identifier (ID) of UE over a future period of time) in the NG-RAN 30. Predicted cell-granularity UE trajectory can be exchanged between gNBs 32 over the Xn interface for AI/ML based mobility optimization. The cell-based UE trajectory prediction may have the same structure as the UE History Information (HI) Information Element (IE) and can be provided as a list of cells through which the UE is predicted to travel together with an expected time that the UE will remain in the cell.

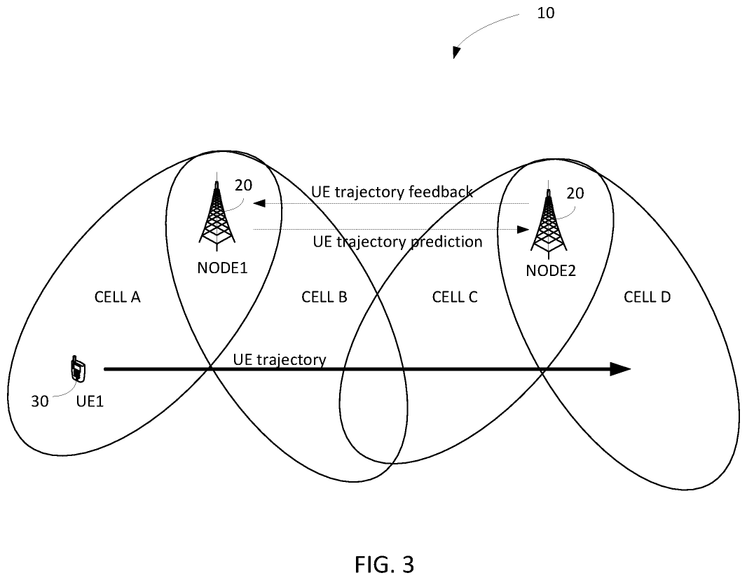

FIG. 3 illustrates an exemplary communication network 10 configured to use UE trajectory position to optimize handovers. The communication network 10 includes a plurality of gNBs 32 providing service to UEs 30 in respective cell of the wireless communication network 10. In this example, a first gNB 32 denoted Node1 serves Cells A and B and a second gNB 32 denoted Node2 serves Cells C and D. UE 1 currently in Cell A is moving along a trajectory towards Cells B, C and D. Node2 has previously subscribed with Node1 to receive UE trajectory predictions. The subscription request specifies one or more conditions for reporting UE trajectory predictions. The conditions may, for example, relate to a mobility event. As one example, Node 2 may request a UE trajectory prediction when UE 1 moves between Cell A and Cell B, or when a cell switch from Cell A to Cell B is imminent. In this example, Node1 sends a UE trajectory prediction to Node2 when UE 1 moves into Cell B or a cell switch to cell B is imminent. As another example, Node 2 may request a UE trajectory prediction when a handover from Cell B to Cell C is imminent. In this example, Node1 sends a UE trajectory prediction to Node2 when a handover or cell switch to cell C is imminent.

In some embodiments, cell-based UE trajectory prediction may be transferred via existing handover (HO) signaling messages. As one example, the cell-based UE trajectory prediction can be signaled from source gNB 32 to target gNB 32 during a handover event using the Handover Request message. When the UE served by the source gNB 32 is about to handover to the target gNB 32, the source gNB 32 sends a Handover Request to a target network node. If the target gNB 32 has subscribed to receive UE trajectory predictions, the handover request includes a UE trajectory prediction. The UE trajectory prediction may be signaled together with mobility related procedures, e.g., Handover Preparation procedure or Retrieve UE Context procedure.

In some embodiments, the RAN nodes subscribing to receive UE trajectory prediction provides UE trajectory feedback to the RAN node providing the UE trajectory prediction. The UE trajectory feedback is the measured UE trajectory. UE trajectory feedback uses the procedure for UE performance feedback reporting as the baseline to also support the measured UE trajectory collection by the source gNB. The UE trajectory feedback may be used to improve the performance of AI/ML algorithms used for predicting UE trajectory.

The Rel-18 of the 3GGP standard introduces a new procedure on the Xn interface to exchange AI/ML-related information (such as predicted information) between NG-RAN nodes. The procedures include a new Class 1 procedure for initiating the reporting of AI/ML-related information and a Class 2 procedure for data reporting of AI/ML-related information. The Class 1 procedure (AI/ML INFORMATION REQUEST/RESPONSE) is used to configure UE performance feedback reporting. The Class 2 non-UE associated procedure (AI/ML INFORMATION UPDATE) is used for UE performance feedback reporting.

There currently exist certain challenges. For example, one problem with the existing technology is that, according to the high-level principles for AI-enabled RAN intelligence, AI/ML model outputs should not be signaled to other nodes without an explicit subscription to the outputs. The cell-based UE trajectory prediction is one such AI/ML model output, and thus, it should only be signaled to nodes requesting the information.

Furthermore, the UE trajectory prediction should be signaled using the existing handover procedure, i.e., via the Handover Request message. However, there is presently no mechanism to request this prediction and no discussion about such a mechanism has happened in 3GPP; hence, it would not be possible to signal this prediction according to the high-level principles for AI-enabled RAN intelligence. Therefore, there is a need to develop such a mechanism.

Certain aspects of the disclosure and their embodiments may provide solutions to these or other challenges. For example, in particular embodiments, a first network node receives a subscription request for UE trajectory prediction information and reports the UE trajectory prediction information to the subscribed network node(s) when certain condition(s) are met.

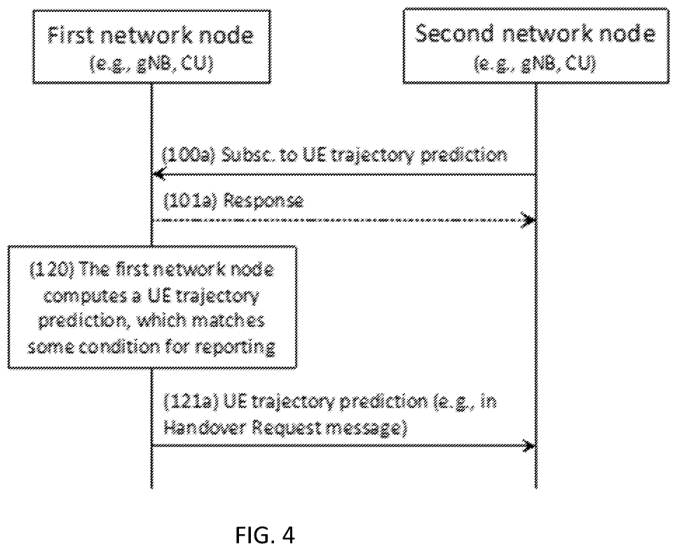

FIG. 4 is a flowchart illustrating an example subscription for trajectory prediction information involving a first and second network node. The first network node may comprise a RAN node currently serving a UE (i.e., source RAN node), and the second network node may comprise a target RAN node to which a handover is imminent or anticipated at some future time. The second network node sends a subscription request to the first network node to subscribe to the UE trajectory prediction service of the first network node (100a). The subscription request may include a condition that, when met, triggers the first network node to send UE trajectory prediction information to the second network node. The first network node accepts the subscription request and sends a response to the second network node indicating that the subscription request was successful (101a). The first network node computes a UE trajectory prediction that matches the condition for reporting in the subscription request (120). Because the condition is fulfilled, the first network node sends UE trajectory prediction information to the second network node (121a). In some embodiment, the UE trajectory prediction information may be sent in a handover request message.

The first network node may derive or obtain the trajectory prediction related to a UE. The trajectory prediction may comprise one or more estimated future paths that the UE is predicted to traverse. The first network node knows or may, at least, estimate the future network node(s), e.g., RAN nodes, that will serve the UE along the estimated path. Whenever the UE changes serving cell, it is referred to as a UE mobility event. Thus, the sequence of estimated future serving cell(s) and network node(s) may be interpreted as a sequence of potential UE mobility events.

The first network node may receive a subscription request for UE trajectory prediction information from a second network node, where the second network node is any network node potentially involved in or affected by any of the one or more potential UE mobility events.

In one example, the second network node is the target node of the first UE mobility event in the sequence of potential UE mobility events. In this example, the first UE mobility event is an imminent UE mobility event that has been triggered or is about to be triggered towards the second network node, e.g., using a (conditional) handover procedure.

In another example, the second network node is the target node of a further, potential UE mobility event in the sequence of potential UE mobility events. In this example, the potential UE mobility event is not an imminent UE mobility event, but it is foreseen that the UE will, with a certain probability, be handed over to the second network node at a future point in time.

One possible sequence of potential UE mobility events may be that the UE moves between cells of the first network node and then moves to a cell of the second network node. In another possible sequence of potential UE mobility events, the UE is predicted to be served by one or more other network nodes before being served by the second network node. In these examples, the second network node is the recipient of the UE trajectory prediction information.

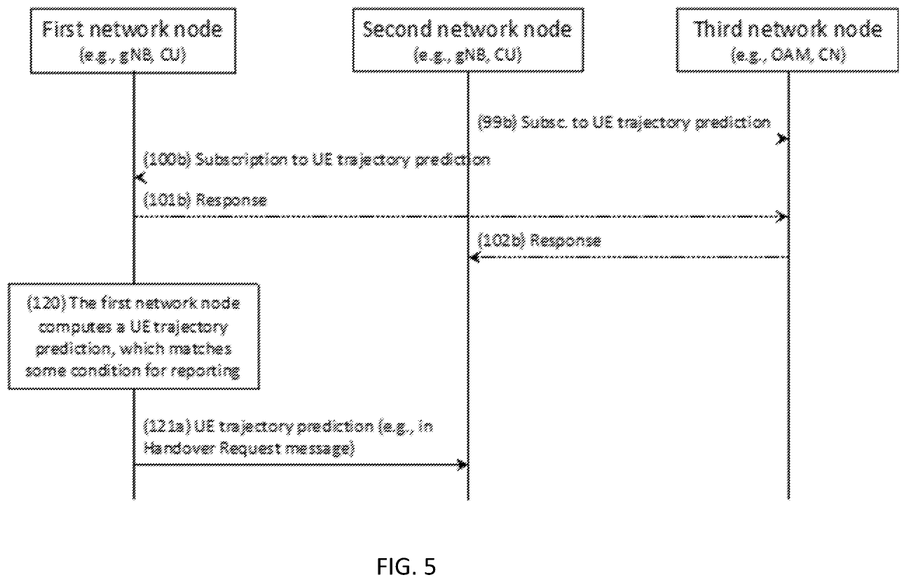

FIG. 5 is a flowchart illustrating an example subscription for trajectory prediction information where a third network node sends the subscription instead of or on behalf of the second network node. The first network node may comprise a RAN node currently serving a UE (i.e., source RAN node) and the second network node may comprise a target RAN node to which a handover is imminent or anticipated at some future time. The third network node may comprise a core network node. The third network node receives a subscription request from the second network node (99b). The third network node sends the subscription request to the first network node on behalf of the second network node to subscribe to the UE trajectory prediction service of the first network node (100a). The subscription request may include a condition that, when met, triggers the first network node to send UE trajectory prediction information to the second network node. The first network node accepts the subscription request and sends a response to the third network node indicating that the subscription request was successful (101a). The third network node forwards the response to the second network node (102b). The first network node computes a UE trajectory prediction that matches the condition for reporting in the subscription request (120). Because the condition is fulfilled, the first network node sends UE trajectory prediction information to the second network node (121a). In some embodiment, the UE trajectory prediction information may be sent in a handover request message.

In this embodiment, the first network node receives a subscription request for UE trajectory prediction information from a third network node, where the third network node is any network node which is not involved in or affected by the potential UE mobility events, e.g., an external system such as an OAM or SMO system or a core network node or function.

In one example, the third network node sends the subscription request for UE trajectory prediction information to the first network node instead of or on behalf of the second network node. In this example, the first network node reports the UE trajectory prediction information to the second network node or, alternatively, to the third network node which would then forward the information to the second network node.

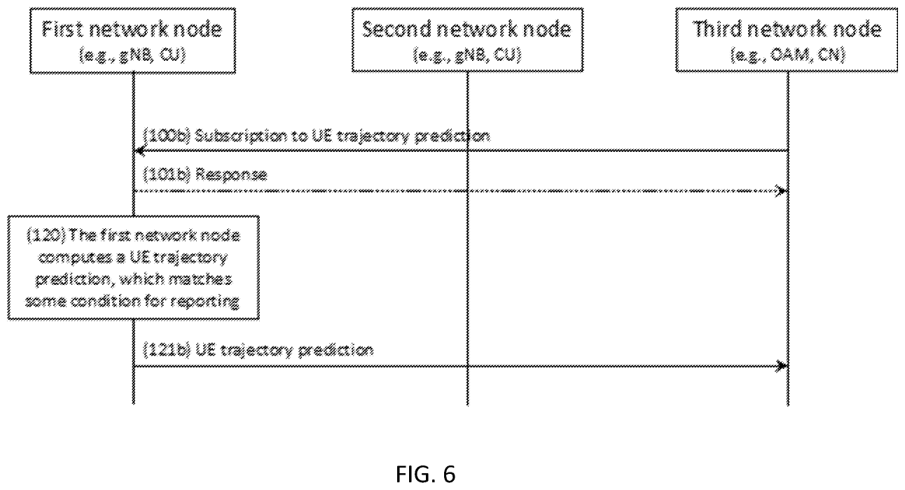

FIG. 6 is a flowchart illustrating an example subscription for trajectory prediction information where the third network node sends the subscription on its own behalf. The third network node may comprise any network node that is not involved in or affected by the potential UE mobility events, such as a core network node, OAM, or SMO. In this embodiment, the third network node sends the subscription request for UE trajectory prediction information to the first network node on its own behalf (100b). The subscription request may include a condition that, when met, triggers the first network node to send UE trajectory prediction information to the third network node. The first network node accepts the subscription request and sends a response to the third network node indicating that the subscription request was successful (101b). The first network node computes a UE trajectory prediction that matches the condition for reporting in the subscription request (120). Because the condition is fulfilled, in this example, the first network node reports the UE trajectory prediction information to the third network node (121b). In this example, the third network node may send a subscription request for UE trajectory prediction information for the purpose of receiving the trajectory prediction directly and deducing optimal configuration and policies for the network, in function of the predicted mobility.

Regarding the signaling of the UE trajectory prediction information, in one example, the reporting of UE trajectory prediction information is not limited to only via handover procedures, but it also involves reporting the UE trajectory prediction information via an alternative message that may consist of a new message or an existing message. The alternative message may, for example, be the new Class 2 procedure so far referred to as AI/ML Information Update and the first network node may report UE trajectory prediction information to the second network node or the third network node via such procedure in a one-off or periodic manner.

In some embodiments, a second network node receives a subscription request for UE trajectory feedback information and reports the said UE trajectory feedback information to the subscribed network node(s) when certain condition(s) are met. The UE trajectory feedback information is historic mobility information related to a UE, which may or may not be related to previously predicted potential UE mobility events.

In general, a first network node may receive a subscription request for UE trajectory prediction information. The subscription request indicates that a second network node and/or a third network node wants to start/resume receiving, or does not need/want to receive anymore, or wants to pause receiving, from the first network node UE trajectory prediction information (in the context of a potential UE mobility event).

In one embodiment, the second network node is any network node potentially involved in or affected by the potential UE mobility event.

In another embodiment, the third network node is any network node that is not involved in or affected by the potential UE mobility event, e.g., an external system such as an OAM or SMO system or a core network node or function.

In one embodiment, the subscription request applies to UE trajectory prediction information for any potential UE mobility event wherein a cell of the first network node is the source cell of the potential UE mobility event and/or a cell of the second network node is the target cell of the (same or another) potential UE mobility event.

When the subscription request for UE trajectory prediction information is received from the second network node and is for any potential UE mobility event wherein the first network node is the source node of the potential UE mobility event and/or the second network node is the target node of the potential UE mobility event, the subscription request may, in some embodiments, be indicated as a flag, e.g., a single bit, in a new (e.g., the AI/ML Information Request message) or an (enhanced) existing procedure between the first network node and the second network node. For example, a bit set to 1 means that UE trajectory prediction information is requested.

In one embodiment, the subscription request for UE trajectory prediction information comprises one or more conditions subject to which the second network node or the third network node needs or wants to start/resume receiving, or does not need/want to receive anymore, or wants to pause receiving, from the first network node UE trajectory prediction information, i.e., the one or more conditions indicating when the first network node is requested to derive and/or signal to the second network node or the third network node UE trajectory prediction information (e.g., depending on the individual UE mobility event).

In one embodiment, the second network node receives a subscription request for UE trajectory feedback information and reports the UE trajectory feedback information to the subscribed network node(s) when certain condition(s) are met. The subscription request for UE trajectory feedback information may be related to a previous subscription request for UE trajectory prediction information, or it may be independent of any previous subscription request for UE trajectory prediction information.

When the subscription request for UE trajectory feedback information is received from the first network node and relates to any UE involved in a UE mobility event, and the first network node is the source node of the UE mobility event and/or the second network node is the target node of the UE mobility event, the subscription request may, in some embodiments, be indicated as a flag, e.g., a single bit, in a new (e.g., the AI/ML Information Request message) or an (enhanced) existing procedure between the first network node and the second network node. For example, a bit set to 1 means that sending UE trajectory feedback information is requested.

Certain embodiments may provide one or more of the following technical advantages. For example, particular embodiments provide a mechanism for a first network node to receive subscription requests for UE trajectory prediction(s) from other network nodes. This is an important feature for AI-enabled RAN intelligence given that there is presently no mechanism to receive these requests whilst, at the same time, there are agreements to signal this type of prediction.

Without a mechanism to subscribe to UE trajectory predictions, the first network node could decide to signal these predictions in every UE mobility event (thus breaking the high-level principle for AI-enabled RAN intelligence agreed in 3GPP that inference outputs should only be signaled if they are requested) or never, because it cannot know if the other network nodes need or make use of the information. If predictions are signaled for every UE mobility event, it is a waste of resources (compute resources, additional signaling overhead, etc.) because it is not expected that this type of prediction is useful in every deployment and for every UE in a mobile network.

Particular embodiments provide the ability to configure conditions according to which the first network node should signal the UE trajectory prediction as well as the ability to configure which particular information the signaled prediction should contain.

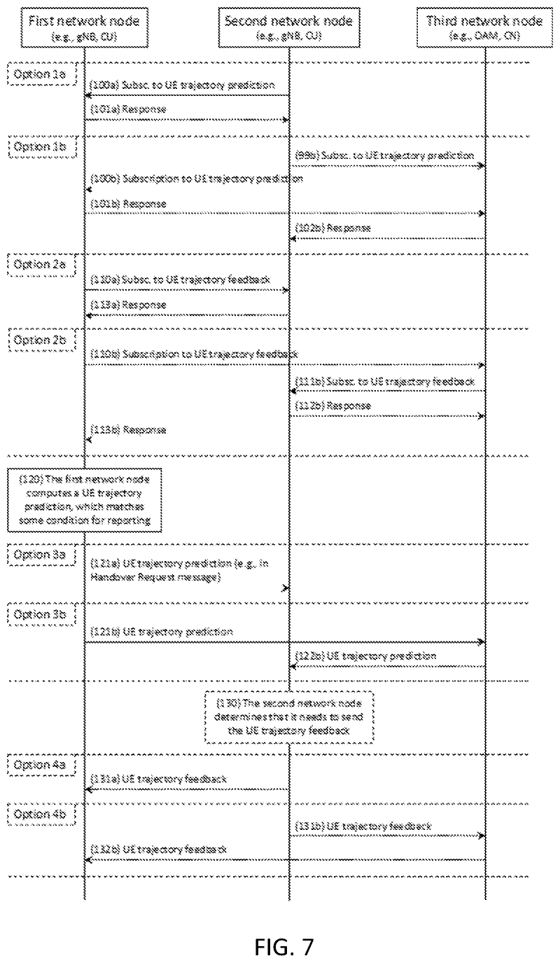

With this overview in mind, some of the embodiments contemplated herein will now be described more fully with reference to FIG. 7. Embodiments are provided by way of example to convey the scope of the subject matter to those skilled in the art.

### Embodiments Related to First RAN Node (e.g., Source RAN Node)

Particular embodiments facilitate a first network node (e.g., a RAN node such as a gNB, or more specifically, a gNB-CU) to derive and/or signal UE trajectory prediction information (associated to at least one UE to be potentially handed over to a second network node at any future point in time) only if/when needed by/at the second network node and/or a third network node, i.e., strictly on a need basis.

FIG. 7 is a flowchart illustrating an example subscription for trajectory prediction information, according to particular embodiments. Similar steps may involve different network nodes, and this is indicated by a letter appended to the step number; for example, step 100 may be performed by the second network node (step 100a) or by the third network node (step 100b).

Some embodiments are related to the first network node. In one embodiment, the first network node may receive a subscription request for UE trajectory prediction information (step 100). The subscription request indicates that another network node needs or wants to start/resume receiving, or does not need/want to receive anymore, or wants to pause receiving, from the first network node UE trajectory prediction information (in the context of a potential UE mobility event). In some embodiments, the subscription request to start/resume/stop/pause the sending of UE trajectory prediction information is realized as a modification of an already existing subscription request.

In one embodiment, the other network node is a second network node, which is any network node potentially involved in or affected by the potential UE mobility event.

In another embodiment, the other network node is a third network node which is any network node that is not involved in or affected by the potential UE mobility event, e.g., an external system such as an OAM or SMO system or a Core Network node or function.

In one embodiment, the subscription request is signaled by the second network node (step 100a). In another embodiment, the subscription request is signaled by the third network node (step 100b).

In one embodiment, the subscription request applies to UE trajectory prediction information for any potential UE mobility event wherein a cell of the second network node is the target cell of the potential UE mobility event.

In another embodiment, the subscription request applies to UE trajectory prediction information for any potential UE mobility event wherein a cell of the first network node is the source cell of the potential UE mobility event.

In another embodiment, the subscription request applies to UE trajectory prediction information for any potential UE mobility event wherein a cell of the first network node is the source cell of the potential UE mobility event and/or a cell of the second network node is the target cell of the (same or another) potential UE mobility event.

In another embodiment, the subscription request applies to UE trajectory prediction information for any potential UE mobility event wherein mobility may occur between cells of the second network node and/or between cells of the second network node and the first network node and/or between cells of the first network node.

In one embodiment, the subscription request applies to UE trajectory prediction information for any UE mobility event that is imminent and wherein one or more cells of the second network node are the target cell(s) of the UE mobility event, e.g., a (conditional) handover procedure associated to the said UE between the first network node and the second network node is being initiated or is about to be initiated.

In another embodiment, the subscription request applies to UE trajectory prediction information for any UE mobility event that is not imminent and wherein one or more cells of the second network node are the target cell(s) of an anticipated future UE mobility event, e.g., the predicted UE trajectory suggests that the second network node is a future serving node of the said UE, with a certain probability.

In one example, an imminent UE mobility event between the first network node and another network node has triggered the first network node to derive or obtain UE trajectory prediction information, and the UE trajectory prediction information suggests that a subsequent future UE mobility event between the other network node and the second network node is likely. In this case, the first network node sends the UE trajectory prediction information to the second network node, provided that the second network node has requested to receive such UE trajectory prediction information.

In some embodiments, the subscription request applies to UE trajectory prediction information for any UE mobility event that is imminent or not imminent and wherein the second network node is the target node (when imminent) or a potential future target node (when not imminent).

In one embodiment, the first network node is the network node serving the UE involved in the potential UE mobility event, i.e., the UE is being served by at least a cell belonging to the first network node. In this case, the first network node may have derived the UE trajectory prediction information by itself, or with the help of the UE or another network node, or the first network node may have obtained the UE trajectory prediction information from the UE or another network node, e.g., upon request.

In another embodiment, the first network node is not the network node serving the UE involved in the potential UE mobility event, but it is a network node providing the UE trajectory prediction information. In this case, the first network node may be a dedicated network node for hosting the Model Inference function, e.g., responsible for performing inference for the network node serving the UE.

When the subscription request received from the second network node is for UE trajectory prediction information for any potential UE mobility event wherein the second network node is the target node of one of the potential UE mobility events, the subscription request may, in some embodiments, be indicated as a flag, e.g., a single bit, in a new or an (enhanced) existing procedure between the first network node and the second network node. For example, a bit set to 1 means that UE trajectory prediction information is requested. The first network node may be configured with instructions describing the characteristics of the UE trajectory prediction information requested, which may map to one of the embodiments above concerning the conditions and characteristics of trajectory predictions.

If the subscription request received from the third network node (e.g., an external system, or a core network node) is for UE trajectory prediction information for any potential UE mobility event wherein the first network node is the source node of one of the potential UE mobility events and/or the second network node is the target node of one of the (same or another) potential UE mobility events, the subscription request may, in some embodiments, be indicated as a flag, e.g., a single bit, in a new or an (enhanced) existing procedure between the first network node and the third network node. The first network node may be configured with instructions describing the characteristics of the UE trajectory prediction information requested, which may map to one of the embodiments above concerning the conditions and characteristics of trajectory predictions.

When the subscription request received from the third network node (e.g., an external system, or a core network node) is for UE trajectory prediction information for any UE mobility event wherein the first network node is the source node of one of the potential UE mobility events, the subscription request may, in some embodiments, be indicated as a flag, e.g., a single bit, in a new or an (enhanced) existing procedure between the first network node and the third network node. The first network node may be configured with instructions describing the characteristics of the UE trajectory prediction information requested, which may map to one of the embodiments above concerning the conditions and characteristics of trajectory predictions.

In some embodiments, the subscription request may be indicated as a list or a table of flags or similar. In this case, a flag comprises a single bit of information, for each neighboring network node, e.g., for each neighboring RAN node, of the first network node, or for none of the neighboring network nodes (e.g., in case of a request to stop/pause sending UE trajectory information). In this way, the subscription request indicates to the first network node which of the second network nodes, e.g., neighboring RAN nodes, the first network node is requested to start/resume sending (or to stop/pause sending) UE trajectory prediction information and which of the second network nodes the first network node is not requested to start/resume sending (or to stop pause sending). The request may apply to some or all of the second network nodes, or to none of the second network nodes.

In one embodiment, upon reception of the subscription request, the first network node signals back to the other network node an acceptance/confirmation or rejection/failure response relating to the request (step 101).

In some embodiments, an acceptance response to the subscription request for UE trajectory prediction comprises an implicit indication that the first network node expects to start/resume receiving (or to stop/pause receiving) UE trajectory feedback information from the second network node and/or the third network node. In this case, the UE trajectory feedback relates to every UE trajectory prediction configured by the subscription request.

In another related embodiment, the request for UE trajectory feedback information is explicitly signaled in the acceptance/confirmation response (step 101) or in another separate message (step 110). In this case, the first network node may configure how and when the UE trajectory feedback should be signaled, i.e., which information should be sent and to which UE mobility events the UE trajectory feedback is related.

In another embodiment, the first network node may request UE trajectory feedback information independently of receiving a request for UE trajectory prediction information and according to the conditions described for how UE trajectory feedback information should be reported. Namely, the first network node may request historic mobility information (i.e., UE trajectory feedback) and use it to, e.g., train/retrain models aimed at inferring UE trajectory predictions.

The description of all possible UE trajectory feedback information maps to the description of the UE trajectory prediction information presented in the embodiments above. Similar conditions on the source and target cells/nodes of the UE mobility events for which feedback is required or similar conditions concerning the reporting of feedback concerning imminent mobility events (happened in the near past) or non-imminent mobility events (happened in the remote past) or both, or conditions concerning the inclusion of time windows representing the time in the past during which occurred mobility events need to be reported, apply.

In one embodiment, upon reception of the subscription request from the third network node (step 100b) and, optionally, transmission of an acceptance/confirmation response to the third network node (step 101b), the first network node may transmit (is expected to transmit) UE trajectory prediction information to the third network node (step 121b), if any, e.g., when the second network node is the target node of a potential UE mobility event. Embodiments Related to Second RAN Node (e.g., Target RAN Node)

Some embodiments are related to the second network node. In one embodiment, the second network node may send a subscription request for UE trajectory prediction information to the first network node or third network node (step 100a, 99b). The subscription request indicates that the second network node needs or wants to start/resume receiving, or does not need/want to receive anymore, or wants to pause receiving, from the first network node UE trajectory prediction information (in the context of a potential UE mobility event). In one case the subscription request to start/resume/stop/pause the sending of UE trajectory prediction information is realized as a modification of an already existing subscription request.

In one embodiment, the subscription request applies to UE trajectory prediction information for any potential UE mobility event wherein a cell of the second network node is the target cell of the potential UE mobility event.

In another embodiment, the subscription request applies to UE trajectory prediction information for any potential UE mobility event wherein a cell of the first network node is the source cell of the potential UE mobility event and/or a cell of the second network node is the target cell of the (same or another) potential UE mobility event.

Further embodiments related to the subscription request were described previously.

In one embodiment, the subscription request is signaled to the first network node (step 100a). In another embodiment, the subscription request is signaled to the third network node (step 99b).

When the subscription request sent to the first network node (step 100a) is for UE trajectory prediction information for any potential UE mobility event wherein the second network node is the target node of one of the potential UE mobility events, the subscription request may, in one related embodiment, be indicated as a flag, e.g., a single bit, in a new or an (enhanced) existing procedure between the first network node and the second network node.

Additionally or alternatively, a third network node (e.g., an external system such as an OAM or SMO, or a core network node) may send a subscription request to the first network node, e.g., instead of/on behalf of the second network node, due to which the second network node may receive (or stop/pause receiving) UE trajectory prediction information from the first network node (e.g., in case the second network node is the target node of a UE mobility event between the first network node and the second network node).

In a related embodiment, the transmission of the subscription request to the first network node is initiated by a request sent from the second network node to the third network node (step 99b). After receiving such a request, the third network node may send the subscription request to the first network node (step 100b).

In one embodiment, after the transmission of the subscription request to the first network node (step 100a), the second network node may receive an acceptance/confirmation or rejection/failure response relating to the request (step 101a).

In some embodiments, if the subscription request was sent to the third network node (step 99b), the second network node may receive an acceptance/confirmation or rejection/failure response relating to the request from the third network node (step 102b).

In some embodiments, an acceptance/confirmation response to the subscription request to start/resume sending UE trajectory prediction information comprises an implicit indication that the second network node should signal UE trajectory feedback information to the first network node. Similarly, if the subscription request is to stop/pause sending UE trajectory prediction information, the response comprise an implicit indication that the second network node should not signal UE trajectory feedback information to the first network node.

In some embodiments, the request for UE trajectory feedback information is explicitly signaled in the acceptance/confirmation response (step 101a) or in another separate message (step 110a).

In some embodiments, the second network node may receive the (implicit or explicit) request for start/stop/pause/resume sending UE trajectory feedback information from the third network node (step 111b).

In some embodiments, if the subscription request was sent to the third network node (step 99b) and, optionally, an acceptance/confirmation response was received from the third network node (step 102b), the second network node may receive UE trajectory prediction information from the third network node (step 122b), e.g., if the second network node is the target node of a UE mobility event between the first and the second network nodes.

When the subscription request received from the third network node (e.g., an external system, or a core network node) is for UE trajectory feedback information for any UE mobility event wherein the second network node is the target node of the UE mobility event, the subscription request may, in some embodiments, be indicated as a flag, e.g., a single bit, in a new or an (enhanced) existing procedure between the second network node and the third network node.

In one embodiment, the second network node signals the UE trajectory feedback information to the first network node (step 131a). In another embodiment, the second network node signals the UE trajectory feedback information to the third network node (step 131b).

Further descriptions of feedback information and ways to request/report it were described in more detail above.

### Embodiments Related to Third Network Node (e.g., Core Network Node)

Some embodiments are related to the third network node. In one embodiment, the third network node may send to the first network node a subscription request for UE trajectory prediction information (step 100b). The subscription request indicates that the second network node needs or wants to receive from the first network node UE trajectory prediction information (in the context of a potential UE mobility event).

Additionally, or alternatively, the third network node may send to the first network node a subscription request for UE trajectory prediction information (step 100b). The subscription request indicates that the third network node needs or wants to receive from the first network node UE trajectory prediction information (in the context of a potential UE mobility event).

In one embodiment, the transmission of the subscription request to the first network node is preceded by a request sent from the second network node to the third network node (step 99b).

In one embodiment, the subscription request applies to UE trajectory prediction information for any potential UE mobility event wherein the second network node is the target node of the potential UE mobility event.

In another embodiment, the subscription request applies to UE trajectory prediction information for any potential UE mobility event wherein the first network node is the source node of the potential UE mobility event and/or the second network node is the target node of the (same or another) potential UE mobility event.

If the subscription request sent to the first network node is for UE trajectory prediction information for any potential UE mobility event wherein the first network node is the source node of the UE mobility event and/or the second network node is the target node of the (same or another) UE mobility event, the subscription request may, in some embodiments, be indicated as a flag, e.g., a single bit, in a new or an (enhanced) existing procedure between the first network node and the third network node (e.g., an external system).

In some embodiments, the subscription request may be indicated as a list or a table of flags or similar. In this case, the flag may comprise a single bit of information, for each neighboring network node, e.g., for each neighboring RAN node, of the first network node. In this way, the third network node (e.g., an external system) can specify or indicate in the subscription request to which other network nodes, e.g., neighboring RAN nodes, the first network node is requested to send UE trajectory prediction information and to which not, e.g., for one or more or all neighboring RAN nodes.

In one embodiment, after the transmission of the subscription request, the third network node may receive an acceptance or rejection response relating to the request (step 101b).

In some embodiments, the third network node may forward the response to the second network node (step 102b), which will receive the requested UE trajectory prediction information.

In a related embodiment, an acceptance response to the subscription request for UE trajectory prediction information implies an implicit indication that the first network node expects UE trajectory feedback information.

In some embodiments, the request for UE trajectory feedback information is explicitly signaled in the acceptance response (step 101b) or in another separate message (step 110b).

In some embodiments, the third network node may forward the request for UE trajectory feedback information to the second network node (step 111b).

In another embodiment, the third network node (e.g., an external system) sends a subscription request to the first network node for UE trajectory prediction information associated to potential UE mobility event(s), e.g., for which the first network node is the source RAN node of the potential UE mobility event(s).

In another embodiment, the third network node (e.g., an external system) sends a subscription request to the second network node for UE trajectory feedback information associated to UE mobility event(s), e.g., for which the second network node is the source or target RAN node of the UE mobility event(s).

In one embodiment, the third network node may receive UE trajectory prediction information from the first network node (step 121b), e.g., if the second network node is the target node of a UE mobility event between the first network node and the second network node.

In some embodiments, the third network node sends a subscription request for UE trajectory prediction information for the purpose of receiving the trajectory prediction directly and deducing optimal configuration and policies for the network, in function of the predicted mobility.

In some embodiments, if the subscription request was originally received from the second network node (step 99b), and an acceptance/confirmation response was received from the first network node (step 101b) and forwarded to the second network node (step 102b), the third network node may forward (is expected to forward) the UE trajectory prediction information to the second network node (step 122b), if any.

### Embodiments Related to Subscription Procedures

In one embodiment, the subscription request for UE trajectory prediction information (step 100) comprises one or more conditions subject to which the second network node or the third network node needs or wants to start/resume receiving, or alternatively, does not need/want to receive UE trajectory predictions, or alternatively, wants to stop/pause receiving UE trajectory predictions from the first network node UE trajectory prediction information. The one or more conditions indicate when the first network node is requested to derive and/or signal to the second network node or the third network node UE trajectory prediction information (e.g., depending on the individual UE mobility event).

In another embodiment, the subscription request for UE trajectory feedback information (step 110, 111) comprises one or more conditions subject to which the first network node or the third network node needs or wants to start/resume receiving, or does not need/want to receive anymore, or wants to stop/pause receiving, from the second network node UE trajectory feedback information. The one or more conditions indicate when the second network node is requested to derive and/or signal to the first network node or the third network node UE trajectory feedback information (e.g., depending on the individual UE mobility event).

In some embodiments, the one or more conditions received by the first network node or the second network node, according to which the UE trajectory prediction information and/or UE trajectory feedback information should be generated and/or reported may be UE mobility event specific or non-UE mobility event specific. Some non-limiting examples for such conditions are outlined hereafter, where the conditions can be considered individually or as the combination of many conditions together:
Source cell (cell of origin) of the UE, e.g., indicated as a list of one or more cell identifiers.
Source node (node of origin) of the UE, e.g., indicated as a list of one or more node identifiers.
Target cell (cell of destination) of the UE, e.g., indicated as a list of one or more cell identifiers. In an example, the target cell(s) may correspond to the first UE mobility event between the first and/or second network nodes or to subsequent UE mobility events between other network nodes.
Target node (node of destination) of the UE, e.g., indicated as a list of one or more node identifiers. In an example, the target node(s) may correspond to the first UE mobility event between the first and/or second network nodes or to subsequent UE mobility events between other network nodes.
Source beam (beam of origin) of the UE, e.g., indicated as a list of one or more beam identifiers.
Target beam (beam of destination) of the UE, e.g., indicated as a list of one or more beam identifiers.
An indication to provide UE trajectory prediction (or UE trajectory feedback) at RAN node level (e.g., indicating an identifier of the RAN node, such as a gNB-ID).
An indication to provide UE trajectory prediction (or UE trajectory feedback) at gNB-DU level.
An indication to provide UE trajectory prediction (or UE trajectory feedback) at the level of one of a function in a RAN node (e.g., a gNB-DU, a Radio Unit).
An indication to provide UE trajectory prediction (or UE trajectory feedback) at cell level.
An indication to provide UE trajectory prediction (or UE trajectory feedback) at carrier frequency level.
An indication to provide UE trajectory prediction (or UE trajectory feedback) at Radio Resource Control (RRC) state level.
An indication to provide UE trajectory prediction (or UE trajectory feedback) at reference signal beam level (or at Synchronization Signaling Block (SSB) area level).
An indication to provide UE trajectory prediction (or UE trajectory feedback) at cell level and at reference signal beam level (or at SSB area level).
An indication of a depth level (or granularity) for the requested UE trajectory prediction (or UE trajectory feedback): an exact depth level, or a minimum depth level, or a maximum depth level. For example, the request concerning UE trajectory prediction (or UE trajectory feedback) may indicate one of the following:
   a depth level equal to cell level: in this case the node receiving the subscription request is requested to provide UE trajectory prediction (or UE trajectory feedback) information only with a per-cell granularity,
   a depth level at least equal to cell level: the node receiving the subscription request is requested to provide UE trajectory prediction (or UE trajectory feedback) at least with a per-cell granularity, and deeper/other granularity(ies) is/are acceptable/may be used (e.g., a UE trajectory prediction with a per reference signal beam granularity (or per-SSB area), or per RRC-state),
   a depth level at most at cell level: the node receiving the subscription request is requested to provide UE trajectory prediction (or UE trajectory feedback) with at most a per-cell granularity, and additional level(s) (or deeper granularity(ies)) is/are not acceptable/cannot be used (e.g., an additional granularity of a per reference signal beam (or per-SSB area), or per RRC-state),
   a depth level equal to reference signal beam (or SSB area): the node receiving the subscription request is requested to provide UE trajectory prediction (or UE trajectory feedback) information only with a per-reference signal beam granularity (or only with a per-SSB area granularity),
   a depth level at least equal to reference signal beam level (or SSB area level): the node receiving the subscription request is requested to provide UE trajectory prediction (or UE trajectory feedback) information at least with a per-reference signal beam granularity (or per-SSB area granularity), and deeper/other granularity(ies) is/are acceptable/can be used (e.g., a UE trajectory prediction with a per cell granularity, or per RRC-state),
   a depth level at most/maximum at reference signal beam level (or per SSB area): the node receiving the subscription request is requested to provide UE trajectory prediction (or UE trajectory feedback) with a per-reference beam or a per-SSB area, and additional level(s) (or deeper granularity(ies)) is/are not acceptable/cannot be used (e.g., an additional granularity of a per cell, or per RRC-state).
An indication related to UE speed and/or direction (predicted or measured), e.g., only for fast moving UEs, only for non-fast moving UEs, UEs with a speed higher than X km/h and in a northbound direction, UEs with a speed lower than X km/h, UEs with a speed between Y km/h and Z km/h, UEs in a certain mobility state—as calculated according to cell (re)-selection criteria—(e.g., only UEs in high mobility state, or UEs in high mobility state or in medium mobility state, or UEs in normal mobility state), etc.
An indication related to predicted dwelling time in some or all of the predicted new/next/target cell(s) and/or beam(s) and/or RAN node(s), e.g., predicted dwelling time in next/target cell and/or beam and/or RAN node(s) less/more than X milliseconds or seconds.
An indication related to time of day, and/or day of week, and/or week of year, etc., e.g., only between 7 am and 9 am.
An indication related to the accuracy and/or uncertainty and/or confidence (level) of the UE trajectory prediction (information), e.g., only when at least 75% certain.
An indication related to the capabilities of the UE, e.g., number of antennas, battery level, etc.
An indication related to the services demanded/consumed by the UE, such as service identifier, service priority, service requirements, service characteristics, etc., e.g., only UEs with Ultra Reliable Low Latency Communication (URLLC) services, Guaranteed Bit Rate (GBR) services, one or more 5G Quality of Service (QoS) Identifiers (5QI), etc.
An indication related to a time duration representing the time window into the future during which UE trajectory predictions and mobility event predictions need to be derived and sent back to the node requesting the predictions.
An indication related to a time duration representing the time window into the past during which UE trajectory feedback and mobility event feedback need to be derived and sent back to the node requesting the feedback.
An indication related to the number of handovers (number of hops) predicted into the future. Namely the number of handovers included in the UE trajectory predictions to be derived and sent back to the node requesting the predictions.
An indication related to the number of handovers (number of hops) occurred in the past. Namely the number of handovers included in the UE trajectory feedback to be derived and sent back to the node requesting the feedback.
In the case of UE trajectory feedback, an indication of when the UE trajectory feedback information should be reported. Some non-limiting examples are outlined hereafter, where the conditions can be considered individually or as the combination of many conditions together:
   Once or multiple times.
   Upon a UE mobility event (e.g., change of UE serving cell).
   Upon the UE being handed over to another network node.
   Upon the UE moving to idle or inactive.
   Upon releasing the UE context.
   Upon expiration of a timer.

In another related embodiment, the subscription request may indicate the priority of the conditions when conditions that trigger the reporting and conditions that stop the reporting are fulfilled simultaneously.

In one embodiment, the first network node may receive from the other network node a detailed subscription request for UE trajectory prediction information. The detailed subscription request may comprise configuration information related to the form/nature of the UE trajectory prediction information. Some non-limiting examples for such indications are given hereafter:
An indication related to the prediction/forecast horizon for the UE trajectory prediction (information) such as:
   An indication related to maximum number of hops (e.g., cells and/or beams), e.g., only next X hops.
   An indication related to minimum number of hops (e.g., cells and/or beams), e.g., at least next X hops.
   An indication related to predicted dwelling time, e.g., only the next hops having a cumulative predicted dwelling time of less than X seconds (in total).
   An indication related to an area where the UE trajectory prediction should apply, e.g., only future cells or beams as long as they are in a particular area.

In one embodiment, the subscription request for UE trajectory prediction information to the first network node (or the subscription request for UE trajectory feedback information to the second network node) may be transmitted using the new AI/ML Information Request message or similar.

In another embodiment, the subscription request for UE trajectory prediction information to the first network node (or the subscription request for UE trajectory feedback information to the second network node) may be transmitted using existing procedures, e.g., Xn Setup procedure (Xn Setup Request message) or NG-RAN node Configuration Update procedure (e.g., NG-RAN node Configuration Update message).

In another embodiment, the subscription request for UE trajectory prediction information to the first network node (or the subscription request for UE trajectory feedback information to the second network node) from an external system such as an OAM or SMO system may involve an update/modification of the Neighbor Cell Relation Table (NCRT) at the first network node.

In another embodiment, the first network node may signal a response related to the acceptance/confirmation or not of the request for UE trajectory prediction information (step 101 in FIG. 7) using a new AI/ML Information Response/Failure message or similar.

In another embodiment, the other network node may signal a response related to the acceptance/confirmation or not of the request for UE trajectory feedback information (step 113 in FIG. 7) using a new AI/ML Information Response/Failure message or similar.

In another embodiment, the first network node may signal a response related to the acceptance/confirmation or not of the request for UE trajectory prediction information (step 101 in FIG. 7) using existing procedures, e.g., Xn Setup procedure (Xn Setup Response/Failure message) or NG-RAN node Configuration Update procedure (NG-RAN node Configuration Update Acknowledge/Failure message).

In another embodiment, the other network node may signal a response related to the acceptance/confirmation or not of the request for UE trajectory feedback information (step 113 in FIG. 7) using existing procedures, e.g., Xn Setup procedure (Xn Setup Response/Failure message) or NG-RAN node Configuration Update procedure (NG-RAN node Configuration Update Acknowledge/Failure message).

The following is an example implementation of Xn signaling with new information elements (IEs) indicated in bold font

### AI/ML Information Request

Direction: NG-RAN node₁→NG-RAN node₂.

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.3.1 | | YES | reject |
| NG-RAN node1 | M | | INTEGER | Allocated by | YES | reject |
| Measurement ID | | | (1 . . . 4095, . . .) | NG-RAN node₁ | | |
| NG-RAN node2 | C- | | INTEGER | Allocated by | YES | ignore |
| Measurement ID | ifRegistrationRequestStop | | (1 . . . 4095, . . .) | NG-RAN node₂ | | |
| Registration | M | | ENUMERATED(start, | Type of request | YES | reject |
| Request | | | stop, . . .) | for which the | | |
| | | | | AI/ML related | | |
| | | | | information is | | |
| | | | | required. | | |
| Report | C- | | BITSTRING | Each position in | YES | reject |
| Characteristics | ifRegistrationRequestStart | | (SIZE(32)) | the bitmap | | |
| | | | | indicates the | | |
| | | | | object the NG- | | |
| | | | | RAN node2 is | | |
| | | | | requested to | | |
| | | | | report. | | |
| | | | | First Bit = | | |
| | | | | Predicted | | |
| | | | | Radio | | |
| | | | | Resource | | |
| | | | | Status, | | |
| | | | | Second Bit = | | |
| | | | | Predicted | | |
| | | | | Number of | | |
| | | | | Active UEs, | | |
| | | | | Third Bit = | | |
| | | | | Predicted RRC | | |
| | | | | connections | | |
| | | | | Fourth Bit = | | |
| | | | | Average UE | | |
| | | | | Throughput DL, | | |
| | | | | Fifth Bit = | | |
| | | | | Average UE | | |
| | | | | Throughput UL, | | |
| | | | | Sixth Bit = | | |
| | | | | Average Packet | | |
| | | | | Delay, | | |
| | | | | Seventh Bit = | | |
| | | | | Average Packet | | |
| | | | | Loss | | |
| | | | | Eighth Bit = | | |
| | | | | Energy Cost | | |
| | | | | Ninth Bit = UE | | |
| | | | | Trajectory | | |
| | | | | Prediction | | |
| | | | | Tenth Bit = UE | | |
| | | | | Trajectory | | |
| | | | | Feedback | | |
| Cell To Report | | 0 . . . 1 | | Cell ID list to | YES | ignore |
| List | | | | which the | | |
| | | | | request applies. | | |
| >Cell To Report | | 1 . . . | | | — | |
| Item | | <maxnoofCellsinNG- | | | | |
| | | RANnode> | | | | |
| >>Cell ID | M | | Global | Cell belonging | — | |
| | | | NG-RAN | to NG-RAN | | |
| | | | Cell | node₂ | | |
| | | | Identity | | | |
| | | | 9.2.2.27 | | | |
| >>NG-RAN | | 0 . . . 1 | | | | |
| node1 Cell List | | | | | | |
| >> NG-RAN | | 1 . . . | | | | |
| node1 Cell | | <maxnoofCellsinNG- | | | | |
| Item | | RANnode> | | | | |
| >>NG-RAN | M | | Global | Target cell of | | |
| node1 Cell ID | | | NG-RAN | handover when | | |
| | | | Cell | requesting UE | | |
| | | | Identity | Trajectory | | |
| | | | 9.2.2.27 | Prediction. | | |
| | | | | Source cell of | | |
| | | | | handover when | | |
| | | | | requesting UE | | |
| | | | | Trajectory | | |
| | | | | Feedback. | | |
| Reporting | O | | ENUMERATED(500 | Periodicity that | YES | ignore |
| Periodicity | | | ms, | can be used for | | |
| | | | 1000 ms, | reporting of | | |
| | | | 2000 ms, | requested | | |
| | | | 5000 ms, | objects. Also | | |
| | | | 10000 | used as the | | |
| | | | ms, . . .) | averaging | | |
| | | | | window length | | |
| | | | | for all objects if | | |
| | | | | supported. | | |
| Requested | O | | FFS | | YES | ignore |
| Prediction Time | | | | | | |

In this example, NG-RAN node 1 can request, for each selected cell in NG-RAN node 2 (specified with the Cell ID IE), UE trajectory prediction information for any UE moving from said cells towards any of its cells or only a subset of them; the latter is achieved by listing the cells of interest using the NG-RAN node 1 Cell List IE.

The following is another example implementation of Xn signaling with new information elements (IEs) indicated in bold font.

### AI/ML Information Request

This message is sent by NG-RAN node1 to NG-RAN node2 to initiate the requested AI/ML related information reporting according to the parameters given in the message.

Direction: NG-RAN node₁→NG-RAN node₂.

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.3.1 | | YES | reject |
| NG-RAN node1 | M | | INTEGER | Allocated by | YES | reject |
| Measurement ID | | | (1 . . . 4095, . . .) | NG-RAN node₁ | | |
| NG-RAN node2 | C- | | INTEGER | Allocated by | YES | ignore |
| Measurement ID | ifRegistrationRequestStop | | (1 . . . 4095, . . .) | NG-RAN node₂ | | |
| Registration | M | | ENUMERATED(start, | Type of request | YES | reject |
| Request | | | stop, . . .) | for which the | | |
| | | | | AI/ML related | | |
| | | | | information is | | |
| | | | | required. | | |
| Report | C- | | BITSTRING | Each position in | YES | reject |
| Characteristics | ifRegistrationRequestStart | | (SIZE(32)) | the bitmap | | |
| | | | | indicates the | | |
| | | | | object the NG- | | |
| | | | | RAN node2 is | | |
| | | | | requested to | | |
| | | | | report. | | |
| | | | | First Bit = | | |
| | | | | Predicted Radio | | |
| | | | | Resource | | |
| | | | | Status, | | |
| | | | | Second Bit = | | |
| | | | | Predicted | | |
| | | | | Number of | | |
| | | | | Active UEs, | | |
| | | | | Third Bit = | | |
| | | | | Predicted RRC | | |
| | | | | connections | | |
| | | | | Fourth Bit = | | |
| | | | | Average UE | | |
| | | | | Throughput DL, | | |
| | | | | Fifth Bit = | | |
| | | | | Average UE | | |
| | | | | Throughput UL, | | |
| | | | | Sixth Bit = | | |
| | | | | Average Packet | | |
| | | | | Delay, | | |
| | | | | Seventh Bit = | | |
| | | | | Average Packet | | |
| | | | | Loss | | |
| | | | | Eighth Bit = | | |
| | | | | Energy Cost | | |
| | | | | Ninth Bit = UE | | |
| | | | | Trajectory | | |
| | | | | Prediction | | |
| | | | | Tenth Bit = UE | | |
| | | | | Trajectory | | |
| | | | | Feedback | | |
| Cell To Report | | 0 . . . 1 | | Cell ID list to | YES | ignore |
| List | | | | which the | | |
| | | | | request applies. | | |
| >Cell To | | 1 . . . | | | — | |
| Report Item | | <maxnoofCellsinNG- | | | | |
| | | RANnode> | | | | |
| >>Cell ID | M | | Global | Cell belonging | — | |
| | | | NG-RAN | to NG-RAN | | |
| | | | Cell | node₂ | | |
| | | | Identity | | | |
| | | | 9.2.2.27 | | | |
| UE Trajectory | | 0 . . . 1 | | | | |
| Information List | | | | | | |
| >UE Trajectory | | 0 . . . | | | | |
| Prediction | | <maxnoofCellsinNG- | | | | |
| Target | | RANnode> | | | | |
| >>NG-RAN | M | | Global | Target cell of at | | |
| node1 Cell ID | | | NG-RAN | least one of the | | |
| | | | Cell | handovers for | | |
| | | | Identity | UE Trajectory | | |
| | | | 9.2.2.27 | Prediction when | | |
| | | | | requesting UE | | |
| | | | | Trajectory | | |
| | | | | Prediction. | | |
| | | | | Source cell of | | |
| | | | | handover when | | |
| | | | | requesting UE | | |
| | | | | Trajectory | | |
| | | | | Feedback. | | |
| >UE Trajectory | | 0 . . . | | | | |
| Feedback | | <maxnoofCellsinNG- | | | | |
| Target | | RANnode> | | | | |
| >>NG-RAN | M | | Global | Target cell of at | | |
| node1 Cell ID | | | NG-RAN | least one of the | | |
| | | | Cell | handovers for | | |
| | | | Identity | UE Trajectory | | |
| | | | 9.2.2.27 | Feedback when | | |
| | | | | requesting UE | | |
| | | | | Trajectory | | |
| | | | | Feedback. | | |
| Number of hops | O | | INTEGER | The number of | | |
| for UE Trajectory | | | (0 . . . 100, . . .) | mobility events | | |
| Prediction | | | | to be reported | | |
| | | | | as part of the | | |
| | | | | UE Trajectory | | |
| | | | | Prediction. | | |
| Number of hops | O | | INTEGER | The number of | | |
| for UE Trajectory | | | (0 . . . 100, . . .) | mobility events | | |
| Feedback | | | | to be reported | | |
| | | | | as part of the | | |
| | | | | UE Trajectory | | |
| | | | | Feedback. | | |
| Time window for | O | | INTEGER | Time window in | | |
| UE Trajectory | | | (0 . . . 300, . . .) | the future for | | |
| Prediction | | | | mobility events | | |
| | | | | to be reported | | |
| | | | | as part of the | | |
| | | | | UE Trajectory | | |
| | | | | Prediction. | | |
| Time window for | O | | INTEGER | Time window in | | |
| UE Trajectory | | | (0 . . . 300, . . .) | the past for | | |
| Feedback | | | | mobility events | | |
| | | | | to be reported | | |
| | | | | as part of the | | |
| | | | | UE Trajectory | | |
| | | | | Feedback. | | |
| Reporting | O | | ENUMERATED(500 | Periodicity that | YES | ignore |
| Periodicity | | | ms, | can be used for | | |
| | | | 1000 ms, | reporting of | | |
| | | | 2000 ms, | requested | | |
| | | | 5000 ms, | objects. Also | | |
| | | | 10000 | used as the | | |
| | | | ms, . . .) | averaging | | |
| | | | | window length | | |
| | | | | for all objects if | | |
| | | | | supported. | | |
| Requested | O | | FFS | | YES | ignore |
| Prediction Time | | | | | | |

The embodiments related to the first network node may be implemented in the near real-time RAN Intelligent Controller (RIC), e.g., in an xApp that collects information from E2 nodes to produce UE trajectory predictions. In some embodiments, the third network node may be implemented in the near real-time RIC.

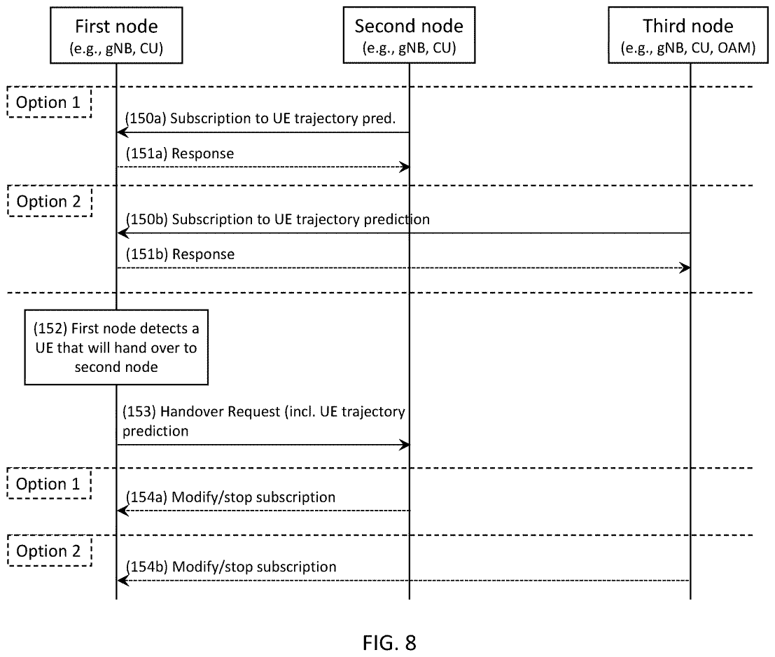

FIG. 8 is a signaling diagram illustrating one implementation of a handover procedure using UE trajectory predictions. FIG. 8 illustrates three network nodes. The first and second network nodes comprise RAN nodes, which may be either gNBs 32 or gNB-CUs 34. The third network node comprises a gNB 32, gNB-CU 34, core network node, or external system providing assistance to or oversight of the second network node. The first network node receives a subscription request from the second network node for UE trajectory predictions for each of one or more UEs in a group of UEs 30 served by the first network node (150a). The first network node answers with a subscription response message to indicate whether the subscription was successful (151a). Alternatively, the first network node receives the subscription request from the third network node (150b). In this case, the subscription request can be sent by the third network node on behalf of the second network node. In the second case, first network node answers with a subscription response message to indicate whether the subscription was successful (151b). In either case, the subscription request for UE trajectory prediction information indicates that the second network node or third network node needs or wants to receive UE trajectory prediction information from the first network node in the context of a UE mobility event.

After the subscription by or on behalf of the second network node is entered, the first network node detects that a UE currently served by the first network node is moving towards the second network node and needs to execute a handover to the second network node (152). When the need for the handover is detected, the first network node sends a handover request message to the second network node (153). The handover request message includes a UE trajectory position for the UE being handed over to the second network node. After the handover is complete, the second network node may optionally send a subscription request message to modify or cancel the subscription with the first network node. (154a). Alternatively, the subscription request to modify or cancel the subscription can be sent by the third network node on behalf of the second network node (154b).

In some embodiments, the subscription request applies to UE trajectory prediction information for any UE mobility event where the first network node is the source node of the UE mobility event and/or the second network node is the target node of the same UE mobility event or is otherwise involved in the same mobility event. The subscription request may originate from a second network node involved or targeted in the mobility event, or from a third network node (e.g., OAM or SMO) affected by or impacted by the mobility event.

In some embodiments, the subscription request for UE trajectory predictions can be indicated by a simple flag, which may comprise a single bit. The flag can be sent in or as part of a new signaling procedure, or as an enhancement of an existing signaling procedure, between the first network node and either the second network node or third network node.

In some embodiments, the subscription request from the third network node may contain a bitmap where each bit corresponds to a neighbor RAN node of the first network node. In this way, the third network node can indicate which neighbor RAN nodes are to receive UE trajectory predictions. The neighbor RAN nodes selected to receive UE trajectory predications may comprise the neighbor RAN nodes (e.g., base stations) most likely to be a handover target.

In some embodiments, the subscription request for UE trajectory predictions may include an indication of one or more conditions subject to which the second network node needs or wants to receive UE trajectory prediction information from the first network node. That is, the one or more conditions can indicate when the first network node is requested to derive and/or signal UE trajectory prediction information to the second network node (e.g., depending on the individual UE mobility event).

In some embodiments, the one or more conditions indicated by the subscription request can be UE mobility event specific or non-UE mobility event specific. Some non-limiting examples for such conditions include:
Source cell (cell of origin) of the UE, e.g., indicated as a list of one or more cell identifiers.
Target cell (cell of destination) of the UE, e.g., indicated as a list of one or more cell identifiers. The target cell(s) could correspond to the first UE mobility event between the first and second network nodes or to subsequent UE mobility events between other network nodes.
Source beam (beam of origin) of the UE, e.g., indicated as a list of one or more beam identifiers.
Target beam (beam of destination) of the UE 40, e.g., indicated as a list of one or more beam identifiers.
UE speed and/or direction, e.g., only for fast moving UEs, UEs with a speed higher than X km/h and in a northbound direction, etc.
Predicted dwelling time of the UE 40 in some or all of the predicted new/next/target cell(s) and/or beam(s), e.g., predicted dwelling time in next/target cell and/or beam less then X seconds.
Time of day, and/or day of week, and/or week of year, etc.
Accuracy and/or uncertainty of the UE trajectory prediction (information).
The capabilities of the UE, e.g., number of antennas, battery level, etc.

In some embodiments, the subscription request for UE trajectory predictions may include an indication of one or more conditions for which the second network node does not need or want to receive UE trajectory prediction information from the first network node. That is, the one or more conditions can indicate when the first network node is requested not to derive and/or signal UE trajectory prediction information to the second network node.

In some embodiments, the subscription request for UE trajectory predictions can provide an indication of the content or format of the UE trajectory predictions to be reported by the first network node. As an example, the content/form indications may relate to the prediction/forecast horizon for the UE trajectory prediction. Non-limiting examples of content/format indications include:
A maximum number of hops (cells and/or beams) in the UE trajectory, e.g., only next X hops.
A minimum number of hops (cells and/or beams) in the UE trajectory, e.g., at least next X hops.
A predicted dwelling time in a cell or beam, e.g., only the next hops having a cumulative predicted dwelling time of less than X seconds (in total).
An area where the UE trajectory prediction should apply, e.g., only future cells or beams as long as they are in a particular area.

In some embodiments, the subscription request for UE trajectory predictions can be transmitted using a new AI/ML Assistance Data Request message or similar message, which may be defined in 3GPP. Similarly, the first network node may signal a response related to the acceptance of the request using a new AI/ML Assistance Data Response/Failure message or similar message to be defined in 3GPP.

In other embodiments, the subscription request for UE trajectory predictions can be transmitted using existing procedures, such as an Xn setup procedure (Xn Setup Request message) or RAN node configuration update procedure (Configuration Update message).

Similarly, the first network node may signal a response related to the acceptance of the request using existing procedures, e.g., Xn setup procedure (Xn Setup Response/Failure message) or RAN node configuration update procedure (Configuration Update Acknowledge/Failure message).

In some embodiments, the subscription request for UE trajectory predictions from a core network node or an external system, such as an OAM or SMO system, can involve an update/modification of the Neighbor Cell Relation Table (NCRT) at the first network node.

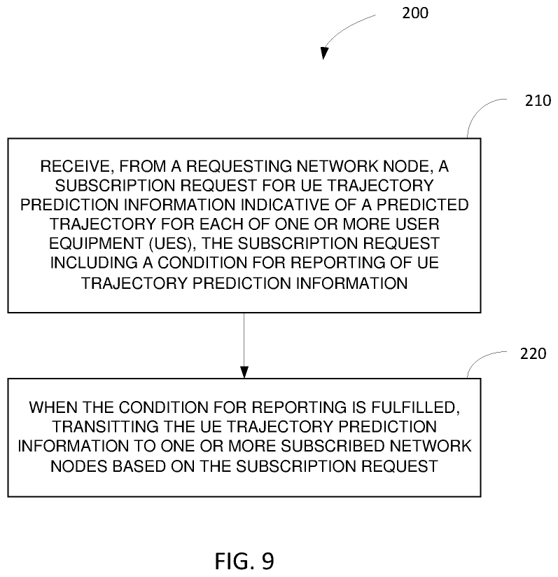

FIG. 9 is an exemplary method 200 implemented by a first RAN node providing UE trajectory predictions to other network nodes. The first RAN node receives a subscription request for user equipment (UE) trajectory prediction information (block 210). The subscription request includes a condition for reporting the UE trajectory information. When the condition for reporting of UE trajectory prediction information is fulfilled, the first RAN node transmits the UE trajectory prediction information to one or more subscribed network nodes based on the subscription request (block 220).

In some embodiments of method 200, the subscription request is from a second RAN node affected by a potential UE mobility event.

In some embodiments of method 200, the condition is related to an imminent mobility event of which one or more cells of the second RAN node are candidate target cells for the imminent mobility event.

In some embodiments of method 200, the condition is related to a non-imminent mobility event of which one or more cells of the second RAN node are candidate target cells for a future anticipated mobility event.

In some embodiments of method 200, the subscription request is from a third network node not affected by a potential UE mobility event.

In some embodiments of method 200, the third network node is a core network node.

In some embodiments of method 200, transmitting the UE trajectory prediction information to one or more subscribed network nodes comprises transmitting the UE trajectory prediction information to at least the third network node.

In some embodiments of method 200, transmitting the UE trajectory prediction information to one or more subscribed network nodes comprises transmitting the UE trajectory prediction information to at least the second RAN node.

In some embodiments of method 200, the subscription request applies to UE trajectory prediction information for any potential UE mobility event wherein a cell of the first RAN node is a source cell of the potential UE mobility event.

In some embodiments of method 200, the subscription request applies to UE trajectory prediction information for any potential UE mobility event wherein a cell of the second RAN node is a target cell of the potential UE mobility event.

In some embodiments of method 200, the potential UE mobility event is an imminent UE mobility event.

In some embodiments of method 200, the first RAN node comprises a network node hosting an artificial intelligence (AI)/machine learning (ML) model inference function.

Some embodiments of method 200 further comprise receiving UE trajectory feedback information from the one or more subscribed network nodes.

In some embodiments of method 200, the first RAN node is RAN node dedicated to providing UE trajectory predictions.

In some embodiments of method 200, the condition for reporting UE trajectory prediction information comprises one or more of:
a source node of a UE mobility event;
a target node of a UE mobility event;
a source cell of a UE mobility event,
a target cell of a UE mobility event;
a source beam of a UE mobility event;
a target beam of a UE mobility event;
UE speed and/or direction;
predicted dwelling time of the UE in a service area;
a time period;
predicted distance or time before a UE mobility event;
geographic area,
accuracy and/or uncertainty of the UE trajectory prediction;
a capability of the UE; and
a service requested by the UE.

In some embodiments of method 200, the subscription request further comprises configuration information for reporting UE trajectory prediction information indicative of a content or format of the UE trajectory predictions to be reported.

In some embodiments of method 200, the configuration information comprises one or more of the following:
a level indicator indicating a granularity of the UE trajectory prediction information;
a depth level of the UE trajectory prediction information;
condition for reporting UE trajectory feedback

In some embodiments of method 200, the level indicator comprises one or more of:
a RAN node level;
a cell level;
a carrier frequency level;
a radio resource control state level;
a reference signal beam level.

In some embodiments of method 200, the depth level of the UE trajectory prediction information comprises one or more of:
a minimum or maximum number of hops;
a cumulative dwelling time of one or more hops;
a geographic area where the UE trajectory prediction applies.

Some embodiments of method 200 further comprise transmitting a request for UE trajectory feedback information to the one or more subscribed network nodes.

In some embodiments of method 200, the first RAN node transmits an acceptance of the subscription request and wherein acceptance of the subscription request comprises an implicit request for UE trajectory feedback information.

In some embodiments of method 200, the first RAN node transmits an explicit request for UE trajectory feedback information to one or more subscribed network nodes.

In some embodiments of method 200, the explicit request for UE trajectory feedback information includes a condition for reporting the UE trajectory feedback information.

In some embodiments of method 200, the condition comprises one or more of:
a mobility event; a change in UE state; release of a UE context; and expiration of a timer

In some embodiments of method 200, the subscription request message contains a flag indicating a request for UE trajectory predictions.

In some embodiments of method 200, the flag may comprise a single bit.

In some embodiments of method 200, the subscription request message contains a bitmap, wherein each bit in the bitmap corresponds to a neighbor node of the source RAN node.

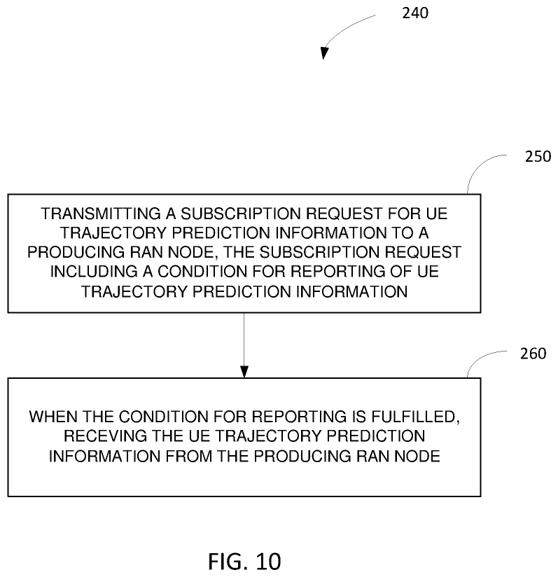

FIG. 10 is an exemplary method 240 implemented by a second RAN node for subscribing with a first RAN node to receive UE trajectory predictions. The second RAN node transmits a subscription request for user equipment (UE) trajectory prediction information to the first RAN node (block 250). The subscription request includes a condition for reporting the UE trajectory information. When the condition for reporting of UE trajectory prediction information is fulfilled, the second RAN node receives the UE trajectory prediction information from the first RAN node (block 260).

In some embodiments of method 240, the second RAN node comprises a network node affected by a potential UE mobility event.

In some embodiments of method 240, the condition is related to an imminent mobility event of which one or more cells of the second RAN node are candidate target cells for the imminent mobility event.

In some embodiments of method 240, the condition is related to a non-imminent mobility event of which one or more cells of the second RAN node are candidate target cells for a future anticipated mobility event.

In some embodiments of method 240, the subscription request applies to UE trajectory prediction information for any potential UE mobility event wherein a cell of the first RAN node is a source cell of the potential UE mobility event.

In some embodiments of method 240, the subscription request applies to UE trajectory prediction information for any potential UE mobility event wherein a cell of the second RAN node is a target cell of the potential UE mobility event.

In some embodiments of method 240, the potential UE mobility event is an imminent UE mobility event.

In some embodiments of method 240, the first RAN node comprises a network node for hosting an artificial intelligence (AI)/machine learning (ML) model inference function.

In some embodiments of method 240, the first RAN node is a RAN node dedicated to providing UE trajectory predictions.

In some embodiments of method 240, transmitting the subscription request to a network node comprises transmitting the subscription request to the first RAN node.

In some embodiments of method 240, transmitting the subscription request to a network node comprises transmitting the subscription request to a third network node for forwarding to the first RAN node.

In some embodiments of method 240, receiving the UE trajectory prediction information from the first RAN node comprises receiving the UE trajectory prediction information via a third network node.

In some embodiments of method 240, the condition for reporting UE trajectory prediction information comprises one or more of:
a source node of a UE mobility event;
a target node of a UE mobility event;
a source cell of a UE mobility event,
a target cell of a UE mobility event;
a source beam of a UE mobility event;
a target beam of a UE mobility event;
UE speed and/or direction;
predicted dwelling time of the UE in a service area;
a time period;
predicted distance or time before a UE mobility event;
geographic area,
accuracy and/or uncertainty of the UE trajectory prediction;
a capability of the UE; and
a service requested by the UE.

In some embodiments of method 240, the subscription request further comprises configuration information for reporting UE trajectory prediction information indicative of a content or format of the UE trajectory predictions to be reported.

In some embodiments of method 240, the configuration information comprises more of the following:
a level indicator indicating a granularity of the UE trajectory prediction information;
a depth level of the UE trajectory prediction information;
condition for reporting UE trajectory feedback

In some embodiments of method 240, the level indicator comprises one or more of:
a RAN node level;
a cell level;
a carrier frequency level;
a radio resource control state level;
a reference signal beam level.

In some embodiments of method 240, the depth level of the UE trajectory prediction information comprises one or more of:
a minimum or maximum number of hops;
a cumulative dwelling time of one or more hops;
a geographic area where the UE trajectory prediction applies.

Some embodiments of method 240 further comprise receiving a request for UE trajectory feedback information from the first RAN node.

In some embodiments of method 240, the second RAN node receives an acceptance of the subscription request and wherein the acceptance of the subscription request comprises an implicit request for UE trajectory feedback information.

In some embodiments of method 240, the second RAN node receives an explicit request for UE trajectory feedback information from one or more subscribed network nodes.

In some embodiments of method 240, the explicit request for UE trajectory feedback information includes a condition for reporting the UE trajectory feedback information.

In some embodiments of method 240, the condition comprises one or more of: a mobility event; a change in UE state; release of a UE context; and expiration of a timer.

Some embodiments of method 240, further comprise transmitting UE trajectory feedback information to the first RAN node.

In some embodiments of method 240, the subscription request message contains a flag indicating a request for UE trajectory predictions.

In some embodiments of method 240, the flag may comprise a single bit.

In some embodiments of method 240, the subscription request message contains a bitmap, wherein each bit in the bitmap corresponds to a neighbor node of the source RAN node.

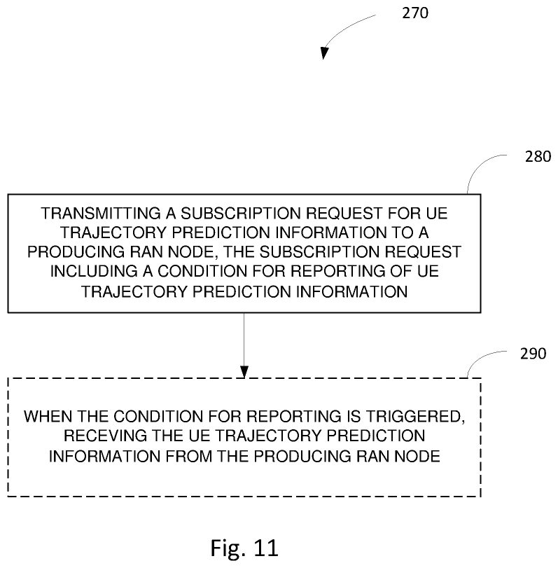

FIG. 11 is an exemplary method 270 implemented by a third network node, which may comprise a RAN node, core network node, OAM, or other node within the wireless communication network 10. The third network node transmits a subscription request for user equipment (UE) trajectory prediction information to the first RAN node (block 280). The subscription request includes a condition for reporting the UE trajectory information. Optionally, when the condition for reporting of UE trajectory prediction information is fulfilled, the third network node receives the UE trajectory prediction information from the first RAN node (block 290). Alternatively, the first RAN node may send the UE trajectory prediction information to another network node specified in the subscription request.

Some embodiments of method 280 further comprise, when the condition for reporting of UE trajectory prediction information is fulfilled, upon triggering of a condition for reporting of UE trajectory prediction information, receiving the UE trajectory prediction information from the first network node.

Some embodiments of method 280 further comprise receiving the subscription request for UE trajectory prediction information from a second RAN node and transmitting the UE trajectory prediction information to the second network RAN node.

In some embodiments of method 280, the third network node comprises a network node not affected by a potential UE mobility event.

In some embodiments of method 280, the subscription request applies to UE trajectory prediction information for any potential UE mobility event wherein a cell of the first network node is a source cell of the potential UE mobility event.

In some embodiments of method 280, the potential UE mobility event is an imminent UE mobility event.

In some embodiments of method 280, the first network node comprises a network node for hosting an artificial intelligence (AI)/machine learning (ML) model inference function.

In some embodiments of method 280, the first RAN node is RAN node dedicated to providing UE trajectory predictions.

In some embodiments of method 280, the condition for reporting UE trajectory prediction information comprises one or more of:
a source node of a UE mobility event;
a target node of a UE mobility event;
a source cell of a UE mobility event,
a target cell of a UE mobility event;
a source beam of a UE mobility event;
a target beam of a UE mobility event;
UE speed and/or direction;
predicted dwelling time of the UE in a service area;
a time period;
predicted distance or time before a UE mobility event;
geographic area,
accuracy and/or uncertainty of the UE trajectory prediction;
a capability of the UE; and
a service requested by the UE.

In some embodiments of method 280, the subscription request further comprises configuration information for reporting UE trajectory information indicative of a content or format of the UE trajectory predictions to be reported.

In some embodiments of method 280, the configuration information comprises one or more of the following:
a level indicator indicating a granularity of the UE trajectory prediction information;
a depth level of the UE trajectory prediction information;
condition for reporting UE trajectory feedback

In some embodiments of method 280, the level indicator comprises one or more of:
a RAN node level;
a cell level;
a carrier frequency level;
a radio resource control state level;
a reference signal beam level.

In some embodiments of method 280, the depth level of the UE trajectory prediction information comprises one or more of:
a minimum or maximum number of hops;
a cumulative dwelling time of one or more hops;
a geographic area where the UE trajectory prediction applies.

Some embodiments of method 280 further comprise receiving a request for UE trajectory feedback information from the first RAN node.

In some embodiments of method 280, the second RAN node receives an acceptance of the subscription request and wherein the acceptance of the subscription request comprises an implicit request for UE trajectory feedback information.

In some embodiments of method 280, the second RAN node receives an explicit request for UE trajectory feedback prediction information to one or more subscribed network nodes.

In some embodiments of method 280, the explicit request for UE trajectory feedback information includes a condition for reporting the UE trajectory feedback information.

In some embodiments of method 280, the condition comprises one or more of: a mobility event; a change in UE state; release of a UE context; and expiration of a timer.

In some embodiments of method 280, the subscription request message contains a flag indicating a request for UE trajectory predictions.

In some embodiments of method 280, the flag may comprise a single bit.

In some embodiments of method 280, the subscription request message contains a bitmap, wherein each bit in the bitmap corresponds to a neighbor node of the source RAN node.

In some embodiments of method 280, the third network node is a core network node.

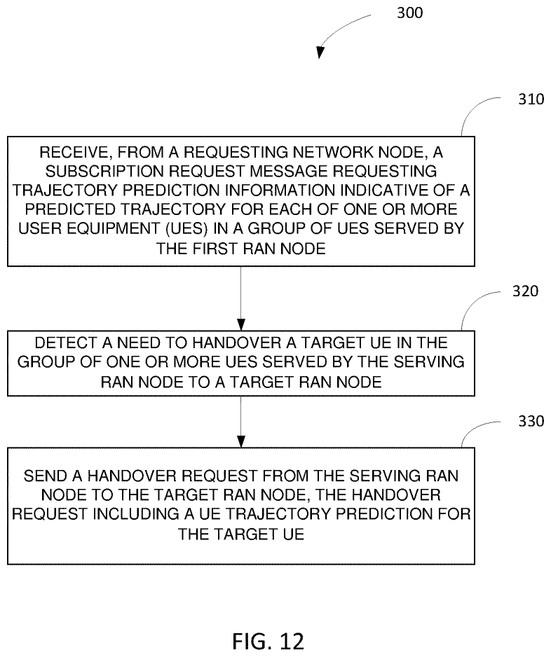

FIG. 12 is an exemplary handover method 300 implemented by a source RAN node (e.g., gNB 32 or gNB-CU 34). The source RAN node receives a subscription request message from another network node, which may be another gNB 32, core network node, or external system, requesting trajectory prediction information indicative of a predicted trajectory for each of one or more UEs in a group of UEs served by the source RAN node (block 310). The source RAN node detects a need to handover a target UE in the group of one or more UEs served by the source RAN node to a target RAN node (block 320). In response to detecting the need for a handover, the source RAN node sends a handover request to the target RAN node. The handover request includes a UE trajectory prediction for the target UE (block 330).

In some embodiments of method 300, the requesting network node is the target RAN node.

In some embodiments of method 300, the requesting network node is a core network node or external system.

In some embodiments of method 300, the subscription request message contains a flag indicating a request for UE trajectory predictions.

In some embodiments of method 300, the subscription request message contains a bitmap, wherein each bit in the bitmap corresponds to a neighbor node of the source RAN node.

In some embodiments of method 300, the subscription request message contains an indication of one or more conditions subject to which the target RAN node needs or wants to receive UE trajectory prediction information from the source RAN node.

In some embodiments of method 300, the one or more conditions includes at least one of source cell of the UE, target cell of the UE; a source beam of the UE; a target beam of the UE; UE speed and/or direction; predicted dwelling time of the UE in a target cell or beam; time period; accuracy and/or uncertainty of the UE trajectory prediction; and a capability of the UE.

In some embodiments of method 300, the subscription request message contains an indication of one or more conditions for which the target RAN node does not need or want to receive UE trajectory prediction information from the source RAN node.

In some embodiments of method 300, the subscription request message contains an indication of the content or format of the UE trajectory predictions to be reported by the source RAN node.

In some embodiments of method 300, the indication of content/format indicates at least one of: a maximum number of hops in the UE trajectory; a minimum number of hops; a predicted dwelling time in a cell or beam; an area where the UE trajectory prediction applies.

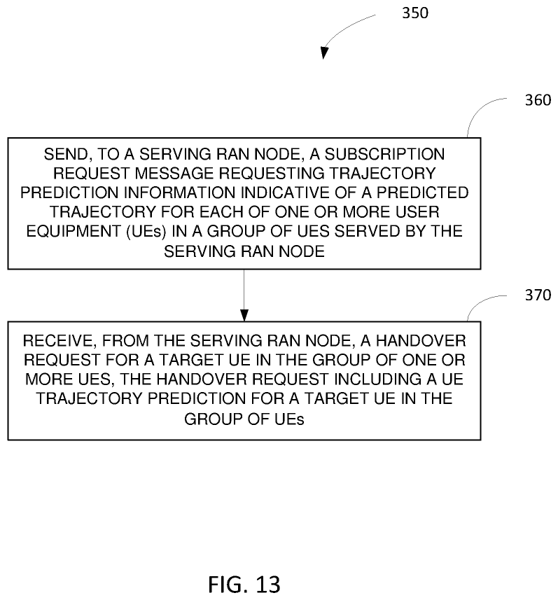

FIG. 13 is an exemplary handover method 350 implemented by a target RAN node (e.g., gNB 32 or gNB-CU 34). The target RAN node sends, to a source RAN node, a subscription request message requesting trajectory prediction information indicative of a predicted trajectory for each of one or more UEs in a group of UEs served by the source RAN node (block 360). The method further comprises receiving, from the source RAN node, a handover request for a target UE in the group of one or more UEs, the handover request including a UE trajectory prediction for a target UE in the group of one or more UEs (block 370).

In some embodiments of method 350, the subscription request message contains a flag indicating a request for UE trajectory predictions.

In some embodiments of method 350, the subscription request message contains a bitmap, wherein each bit in the bitmap corresponds to a neighbor node of the source RAN node.

In some embodiments of method 350, the subscription request message contains an indication of one or more conditions subject to which the target RAN node needs or wants to receive UE trajectory prediction information from the source RAN node.

In some embodiments of method 350, the one or more conditions includes at least one of source cell of the UE, target cell of the UE; a source beam of the UE; a target beam of the UE; UE speed and/or direction; predicted dwelling time of the UE in a target cell or beam; time period; accuracy and/or uncertainty of the UE trajectory prediction; and a capability of the UE.

In some embodiments of method 350, the subscription request message contains an indication of one or more conditions for which the target RAN node does not need or want to receive UE trajectory prediction information from the source RAN node.

In some embodiments of method 350, the subscription request message contains an indication of the content or format of the UE trajectory predictions to be reported by the source RAN node.

In some embodiments of method 350, the indication of content/format indicates at least one of: a maximum number of hops in the UE trajectory; a minimum number of hops; a predicted dwelling time in a cell or beam; an area where the UE trajectory prediction applies.

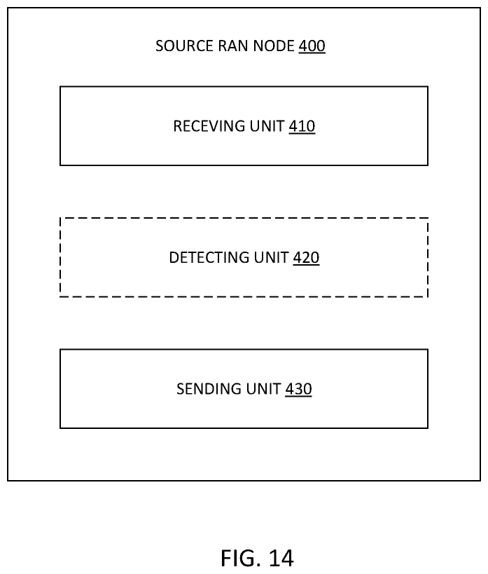

FIG. 14 illustrates an exemplary source RAN node 400 providing a UE trajectory prediction service. The source RAN node 400 comprises a receiving unit 410, a detecting unit 420, and a sending unit 430. The units 410-430 may be implemented by hardware and/or by software code that is executed by one or more processors or processing circuits. The receiving unit 410 is configured to receive, from a requesting network node, a subscription request message requesting trajectory prediction information indicative of a predicted trajectory for each of one or more UEs in a group of UEs served by the source RAN node 400. The subscription request message may contain a condition for reporting UE trajectory prediction information, which may comprise a mobility event. The detecting unit 420 is configured to detect fulfillment of the condition. The sending unit 430 is configured to send a handover request from the source RAN node to the target RAN node when the condition is fulfilled. The handover request including a UE trajectory prediction for the target UE.

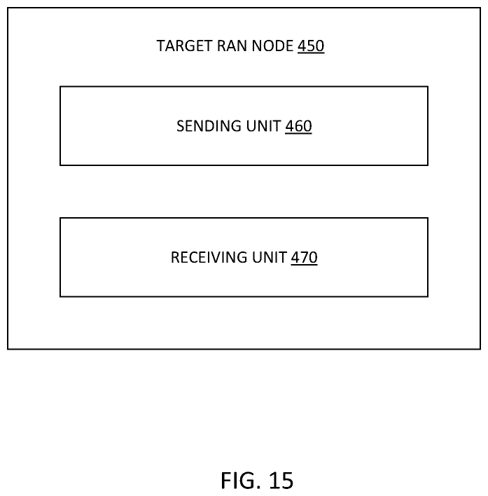

In one embodiment the condition relates to a handover between the source RAN node 400 and a target RAN node 450 (FIG. 15). The detecting unit 420 detects a need to handover a target UE in the group of one or more UEs served by the source RAN node to a target RAN node and, responsive to the imminent handover, sends UE trajectory prediction information to the target RAN node.

FIG. 15 illustrates an exemplary target RAN node 450 (e.g., gNB 32 or gNB-CU 34). The target RAN node 450 comprises a sending unit 460 and a receiving unit 470. The units 460-470 may be implemented by hardware and/or by software code that is executed by one or more processors or processing circuits. The sending unit 460 is configured to send, to a source RAN node, a subscription request message requesting trajectory prediction information indicative of a predicted trajectory for each of one or more UEs in a group of UEs served by the source RAN node. The receiving unit 470 is configured to receive, from the source RAN node, a handover request for a target UE in the group UEs, the handover request including a UE trajectory prediction for the target UE.

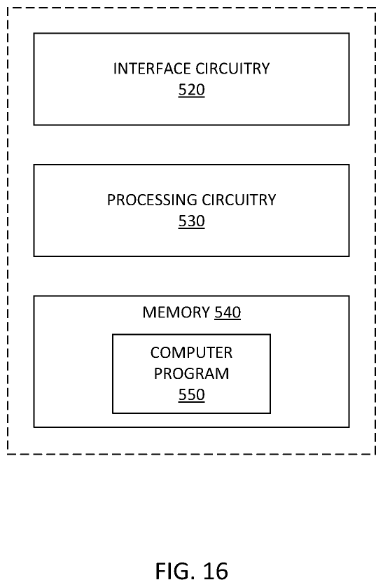

FIG. 16 illustrates the main functional components of a network node 500, which can be configured to provide or subscribe to a UE trajectory prediction service. The network node 500 may comprise a RAN node or core network node. The network node 500 comprises interface circuitry 520, processing circuitry 530, and memory 540. The interface circuitry 520 comprises circuitry providing a network interface for communication with other RAN nodes, core network nodes, and or external systems. The processing circuitry 530 comprises one or more microprocessors, hardware, firmware, or a combination thereof, that control the overall operation of the network node 500. The processing circuitry 530 can be configured by software to perform the one or more of the methods shown in FIGS. 9-13 and described herein.

Memory 540 comprises both volatile and non-volatile memory for storing computer program code and data needed by the processing circuitry 530 for operation. Memory 540 may comprise any tangible, non-transitory computer-readable storage medium for storing data including electronic, magnetic, optical, electromagnetic, or semiconductor data storage. Memory 540 stores a computer program 550 comprising executable instructions that configure the processing circuit 530 in the RAN node 500 to perform one or more of the methods shown in FIGS. 9-13 and described herein. A computer program 550 in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 550 for configuring the processing circuitry 530 as herein described may be stored in a removable memory, such as a portable compact disc, portable digital video disc, or other removable media. The computer program 550 may also be embodied in a carrier such as an electronic signal, optical signal, radio signal, or computer readable storage medium.

Those skilled in the art will also appreciate that embodiments herein further include corresponding computer programs 550. A computer program 550 comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

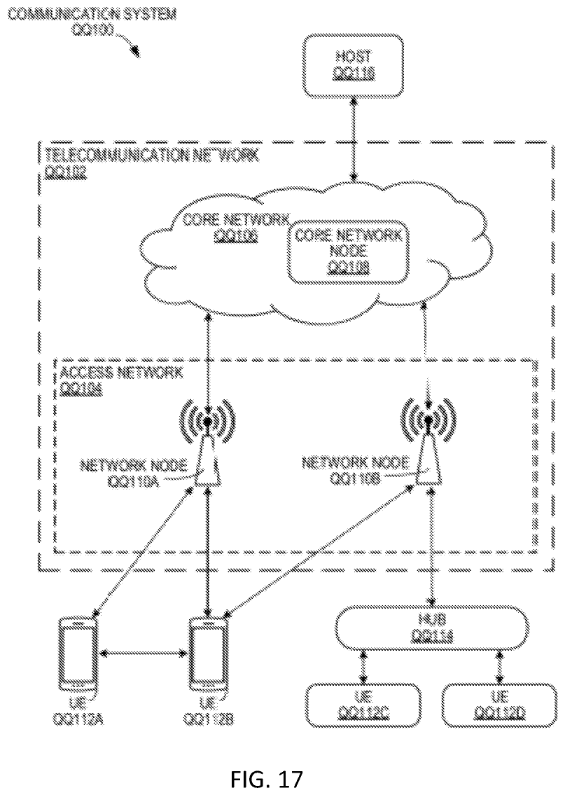

FIG. 17 shows an example of a communication system QQ100 in accordance with some embodiments. In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 17 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

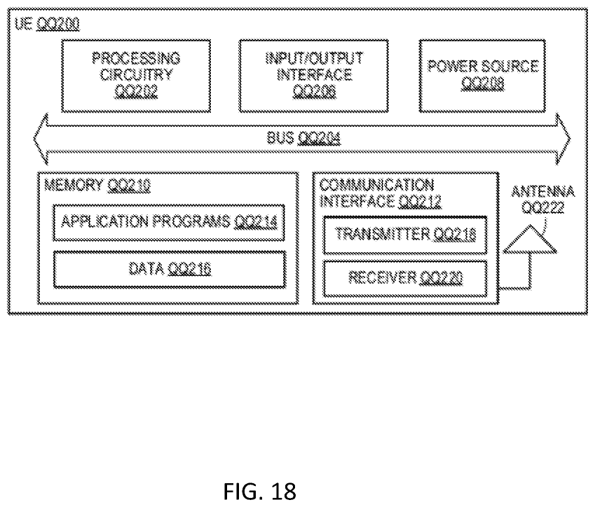

FIG. 18 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 18. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 18.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

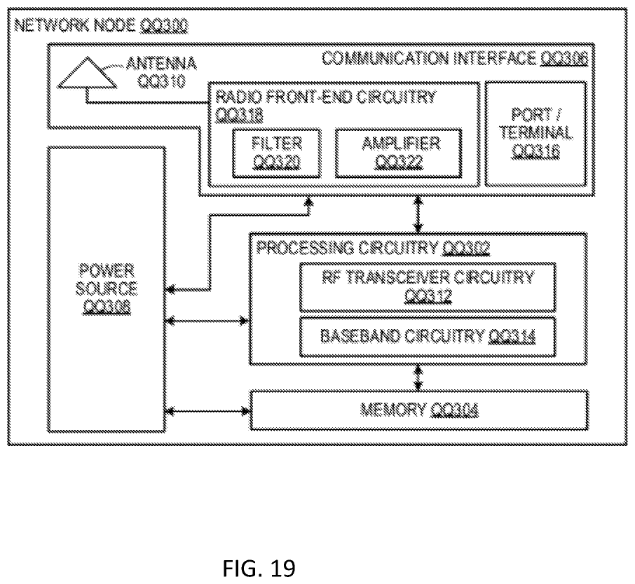

FIG. 19 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 19 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

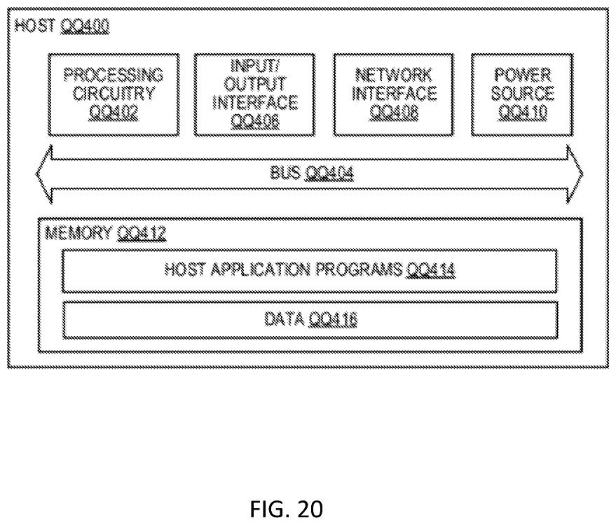

FIG. 20 is a block diagram of a host QQ400, which may be an embodiment of the host QQ116 of FIG. 17, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source

QQ410, and a memory QQ412. Other components may be included in other embodiments. Features of these components may be substantially similar to those described with respect to the devices of previous figures, such as Figures QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

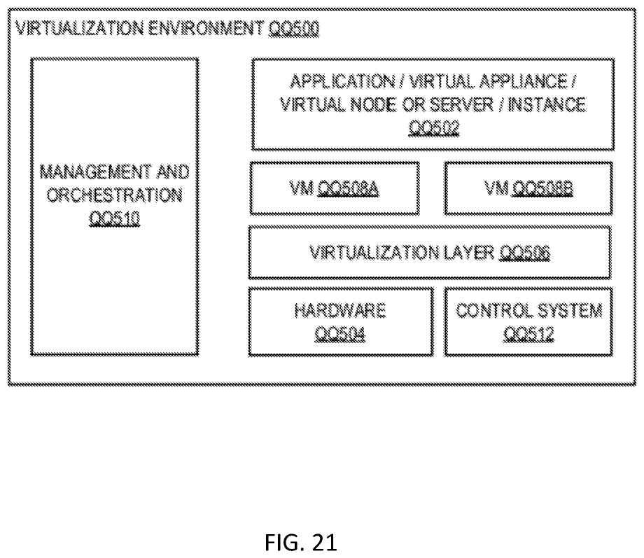

FIG. 21 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

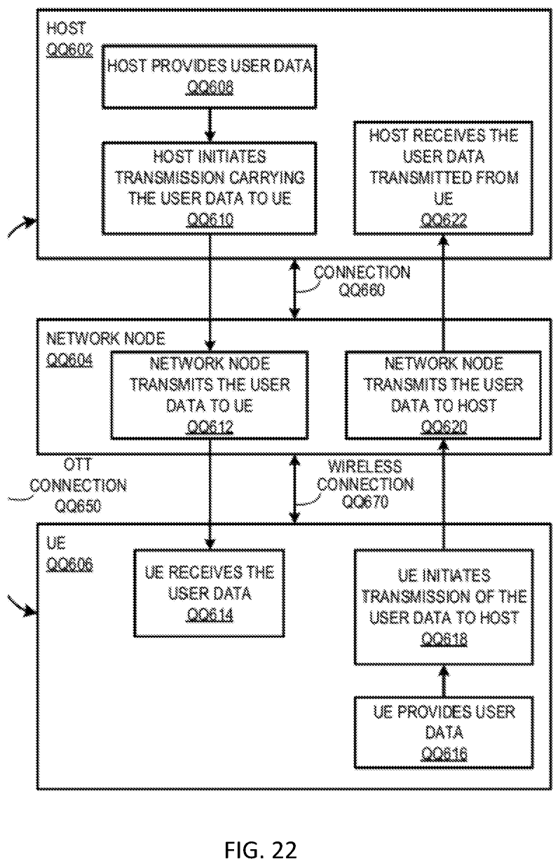

FIG. 22 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 17 and/or UE QQ200 of FIG. 18), network node (such as network node QQ110a of FIG. 17 and/or network node QQ300 of FIG. 19), and host (such as host QQ116 of FIG. 17 and/or host QQ400 of FIG. 20) discussed in the preceding paragraphs will now be described with reference to FIG. 22.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 17) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1-94. (canceled)

95. A method performed by a first radio access network (RAN) node configured to provide UE trajectory predictions, the method comprising:
receiving a subscription request for user equipment (UE) trajectory prediction information, the subscription request including a condition for reporting the UE trajectory prediction information; and
when the condition for reporting of UE trajectory prediction information is fulfilled, transmitting the UE trajectory prediction information to one or more subscribed network nodes based on the subscription request.

96. The method of claim 95, wherein the subscription request is from a second RAN node affected by a potential UE mobility event.

97. The method of claim 96, wherein the condition is related to a mobility event of which one or more cells of the second RAN node are candidate target cells for the mobility event.

98. The method of claim 95, wherein the subscription request is from a third network node and the third network node comprises a network node not affected by a potential UE mobility event.

99. The method of claim 98, wherein the third network node is a core network node.

100. The method claim 95, wherein the subscription request applies to UE trajectory prediction information for any potential UE mobility event wherein a cell of the first RAN node is a source cell of the potential U E mobility event.

101. The method of claim 95, wherein the subscription request applies to UE trajectory prediction information for any potential UE mobility event wherein a cell of a second RAN node is a target cell of the potential UE mobility event.

102. The method of claim 95, wherein the condition for reporting UE trajectory prediction information comprises one or more of:
a source node of a UE mobility event;
a target node of a UE mobility event;
a source cell of a UE mobility event,
a target cell of a UE mobility event;
a source beam of a UE mobility event;
a target beam of a UE mobility event;
UE speed and/or direction;
predicted dwelling time of the UE in a service area;
a time period;
predicted distance or time before a UE mobility event;
geographic area,
accuracy and/or uncertainty of the UE trajectory prediction;
a capability of the UE; and
a service requested by the UE.

103. The method of claim 95, wherein the subscription request further comprises configuration information for reporting UE trajectory prediction information indicative of a content or format of the UE trajectory predictions to be reported.

104. The method of claim 95, wherein the subscription request message contains a flag indicating a request for UE trajectory predictions, wherein the flag comprises a single bit.

105. A method performed by a second RAN node configured to receive UE trajectory predictions, the method comprising:
transmitting a subscription request for user equipment (UE) trajectory prediction information to a first RAN node, the subscription request including a condition for reporting the UE trajectory prediction information; and
when the condition for reporting of UE trajectory prediction information is fulfilled, receiving the UE trajectory prediction information from the first RAN.

106. The method of claim 105, wherein the second RAN node comprises a network node affected by a potential UE mobility event.

107. The method of claim 105, wherein the condition is related to a mobility event of which one or more cells of the second RAN node are candidate target cells for the mobility event.

108. The method of claim 105, wherein the subscription request applies to UE trajectory prediction information for any potential UE mobility event wherein a cell of the second RAN node is a target cell of the potential UE mobility event.

109. The method of claim 105, wherein the subscription request applies to UE trajectory prediction information for any potential UE mobility event wherein a cell of the first RAN node is a source cell of the potential UE mobility event.

110. The method of claim 105, wherein the condition for reporting UE trajectory prediction information comprises one or more of:
a source node of a UE mobility event;
a target node of a UE mobility event;
a source cell of a UE mobility event,
a target cell of a UE mobility event;
a source beam of a UE mobility event;
a target beam of a UE mobility event;
UE speed and/or direction;
predicted dwelling time of the UE in a service area;
a time period;
predicted distance or time before a UE mobility event;
geographic area,
accuracy and/or uncertainty of the UE trajectory prediction;
a capability of the UE; and
a service requested by the UE.

111. The method of claim 105, wherein the subscription request further comprises configuration information for reporting UE trajectory prediction information indicative of a content or format of the UE trajectory predictions to be reported.

112. The method of claim 105, wherein the subscription request message contains a flag indicating a request for UE trajectory predictions, wherein the flag comprises a single bit.

113. A RAN node in a wireless communication network, the RAN node comprising:
interface circuitry for communicating with other network nodes in the wireless communication network;
processing circuitry operatively connected to the interface circuitry and configured to:
receive a subscription request for user equipment (UE) trajectory prediction information, the subscription request including a condition for reporting the UE trajectory prediction information; and
when the condition for reporting of UE trajectory prediction information is fulfilled, transmit the UE trajectory prediction information to one or more subscribed network nodes based on the subscription request.

114. A RAN node in a wireless communication network, the RAN node comprising:
interface circuitry for communicating with other network nodes in the wireless communication network;
processing circuitry operatively connected to the interface circuitry and configured to:
transmit a subscription request for user equipment (UE) trajectory prediction information to a first RAN nod), the subscription request including a condition for reporting the UE trajectory prediction information; and
when the condition for reporting of UE trajectory prediction information is fulfilled, receiving the UE trajectory prediction information from the first RAN node.
